(19) United States
(12) Patent Application Publication
(10) Pub. No.: US 2022/0361990 A1
(43) Pub. Date: Nov. 17, 2022

(54) APPARATUS FOR IN-SITU RECONDITIONING OF A DENTAL IMPLANT

(71) Applicant: Rishon Mor Investments Ltd., Tel-Aviv (IL)

(72) Inventors: Amiram VIZANSKI, Herzlia (IL); Aviv VIZANSKI, Herzlia (IL)

(73) Assignee: Rishon Mor Investments Ltd., Tel-Aviv (IL)

(21) Appl. No.: 17/762,781

(22) PCT Filed: Sep. 24, 2020
(86) PCT No.: PCT/IL2020/051049

§ 371 Date: Mar. 23, 2022

Related U.S. Application Data
(60) Provisional application No. 62/905,436, filed on Sep. 25, 2019.

(51) Int. Cl. A61C 8/00

(52) U.S. Cl. CPC A61C 8/0089

(57) ABSTRACT

A device for treating a dental implant in-situ, the device including a shaft, and a plurality of machining tools attached to the shaft at a location between the ends of the shaft, tips of the machining tools arranged to rotate around a longitudinal axis of the shaft when the shaft rotates. A guide for a device for treating a dental implant in-situ, the guide including a first portion shaped as a cylinder, and a second portion with a diameter small enough to fit into a hole in a center of a dental implant, wherein a longitudinal axis of the cylinder of the first portion is concentric with a longitudinal axis of the second portion. Related apparatus and methods are also described.

### RELATED APPLICATION

This application is a PCT Patent application claiming priority from U.S. Provisional Patent Application No. 62/905,436 filed on 25 Sep. 2019, the contents of which are incorporated herein by reference in their entirety.

### FIELD AND BACKGROUND OF THE INVENTION

The present invention, in some embodiments thereof, relates to devices and methods for treating a dental implant in-situ.

A problem which occasionally occurs after impaling dental implant is a gradual loss of bone around the dental implant. In some cases the loss of bone can happen around one implant and not around a neighboring implant.

Various methods and devices for treating dental implants in-situ, still implanted in a patient's jaw, are presently used.

Additional background art includes:

Published US patent application No. US 2018/153657 of Scmidlin;

Published US patent application No. US 2015/282907 of Zipprich;

Published US patent application No. US 2015/072308 of Kim;

Published US patent application No. US 2014/106295 of Wade et al;

Published US patent application No. US 2010/291506 of Olsson et al;

PCT patent application publication No. WO 2017 069298 of Kim;

Korea patent application No. KR 20180122148;

Korea patent application No. KR 101967577;

China patent application No. CN 108969132; and

PCT patent application publication No. WO 2016/023998;

The disclosures of all references mentioned above and throughout the present specification, as well as the disclosures of all references mentioned in those references, are hereby incorporated herein by reference.

### SUMMARY OF THE INVENTION

The present invention, in some embodiments thereof, relates to devices and methods for treating a dental implant in-situ.

A dental implant for which treatment is planned is an implant left in place, in-situ, in a patient's jaw.

In some embodiments a crown and/or abutment are detached from the implant, and only the implant is left in the jaw.

In some embodiments a dental practitioner optionally removes infected tissue in the vicinity of the dental implant before treating the dental implant.

An outside surface of the dental implant is optionally treated, by vigorous cleaning, or by machining off an outer layer.

In some embodiments threading on the outer surface of the dental implant are optionally partially removed.

In some embodiments threading on the outer surface of the dental implant are optionally completely removed, optionally leaving a smooth outer surface.

In some embodiments an outer surface of the dental implant is treated by debriding. The outer surface of the dental implant is ground away, eliminating contaminated surfaces and reveal a new machined surface of a diseased implant, potentially reconditioned to a state ready for reintegration with surrounding bone.

The term implantoplasty is sometimes used to for treating a dental implant as described herein with reference to some embodiments.

According to an aspect of some embodiments of the present invention there is provided a device for treating a dental implant in-situ, the device including a shaft, and a plurality of machining tools attached to the shaft at a location between the ends of the shaft, tips of the machining tools arranged to rotate around a longitudinal axis of the shaft when the shaft rotates.

According to some embodiments of the invention, the shaft includes a concentric hole at one end, the hole sized and shaped to slide over a guide for steadying the shaft when rotating.

According to some embodiments of the invention, the tools are attached to the shaft by hinges, the hinges enabling the tool tips to move in a radial direction relative to the longitudinal axis of the shaft.

According to some embodiments of the invention, further including an adjustment nut, the adjustment nut arranged to move the tool tips in the radial direction relative to the longitudinal axis of the shaft.

According to some embodiments of the invention, the adjustment nut is a knurled adjust nut, suitable for adjust by hand and/or manipulation by hand.

According to some embodiments of the invention, the tool is shaped to prevent the device from sliding back off the guide.

According to some embodiments of the invention, the tool includes a spring configured to prevent the device from sliding back off the guide.

According to some embodiments of the invention, further including markings on the shaft for displaying a position of the adjustment nut along the shaft.

According to some embodiments of the invention, the hinges are included in a tool carrier attached to or included in the shaft.

According to some embodiments of the invention, the tools include a tool tip for cutting a dental implant.

According to some embodiments of the invention, the device is configured to rotate the machining tool at a speed of rotation in a range from 300 to 1000 RPM.

According to some embodiments of the invention, the tool tip is an insert configured to be attached to the tool.

According to some embodiments of the invention, the tool tip is an insert configured to be inserted into a corresponding cavity in the tool.

According to some embodiments of the invention, the insert includes a material selected from a group consisting of Tungsten, and Zirconium.

According to some embodiments of the invention, the tool tip is hardened to a Rockwell value in a range from 49 Rockwell to 58 Rockwell.

According to some embodiments of the invention, the tool tip is arranged to contact an outer surface of a dental implant at a location slightly behind a point where the radial direction relative to the longitudinal axis of the shaft intercepts the outer surface of the dental implant.

According to some embodiments of the invention, the tools include at least two separate parts connected to each other, a first arm part and a second a tool part.

According to some embodiments of the invention, the first arm part is made of a material with different properties than the second tool part.

According to some embodiments of the invention, wherein the first arm part is made of a spring material.

According to some embodiments of the invention, the tools include a components selected from a group consisting of a brush, an abrasive, and an abrasive mount.

According to an aspect of some embodiments of the present invention there is provided a device for treating a dental implant in-situ, the device including a shaft including a tip sized and shaped to slide into a hole in a dental implant for steadying the shaft around the dental implant when rotating, and a plurality of tools attached to the shaft at a location between the ends of the shaft, the tool tips arranged to rotate around a longitudinal axis of the shaft when the shaft rotates.

According to an aspect of some embodiments of the present invention there is provided a guide for a device for treating a dental implant in-situ, the guide including a first portion shaped as a cylinder, and a second portion with a diameter small enough to fit into a hole in a center of a dental implant, wherein a longitudinal axis of the cylinder of the first portion is concentric with a longitudinal axis of the second portion.

According to some embodiments of the invention, the first portion has a smooth outer surface.

According to some embodiments of the invention, the first portion has a diameter small enough to slide into a hole in a center of a shaft of the device.

According to some embodiments of the invention, the second portion includes a thread sized and shaped to screw into a dental implant.

According to some embodiments of the invention, the second portion includes a lip sized and shaped to sit on top of a dental implant and extends radially further than a radius of the dental implant.

According to some embodiments of the invention, further including the second portion being sized and shaped to conform to an inside hole of a dental implant.

According to some embodiments of the invention, the second portion includes a top end shaped as a conical shape sized and shaped to conform to an inside hole of a dental implant.

According to some embodiments of the invention, a length of the second portion is selected to be equal to a length of an internal hole in a dental implant.

According to some embodiments of the invention, the first portion includes markings along its length arranged to display a distance along the first portion.

According to an aspect of some embodiments of the present invention there is provided a guide for a device for treating a dental implant in-situ, the guide including a first portion thin enough to slide into a hole in a center of a shaft of the device, and a second portion thin enough to slide into a hole in a center of a dental implant, wherein a longitudinal axis of the first portion is concentric with a longitudinal axis of the second portion.

According to an aspect of some embodiments of the present invention there is provided a kit including a device as described above and a guide as described above.

According to an aspect of some embodiments of the present invention there is provided a method for treating a dental implant in-situ, the method including providing a device according as described above, centering the device over a dental implant and sliding onto a guide, adjusting treating tools to press onto an outer surface of the dental implant, and lowering the device onto the guide, thereby lowering the tools along the outer surface of the dental implant, thereby treating the outer surface of the dental implant.

According to some embodiments of the invention, the treating tools are rotated at a rotation rate in a range between 300 and 1000 RPM.

According to some embodiments of the invention, further including suctioning cut-off flakes of the dental implant material away.

According to some embodiments of the invention, further including treating the outer surface of the dental implant without irrigating the dental implant to cool the dental implant.

According to some embodiments of the invention, the guide is screwed into the dental implant before the device is slid over the guide.

According to some embodiments of the invention, further including further adjusting the treating tools to press further onto the outer surface of the dental implant, and pulling the device up along the guide.

According to some embodiments of the invention, further including repeating a lowering and pulling up of the device along the guide.

According to some embodiments of the invention, the treating the outer surface of the dental implant includes removing an outer layer of metal from the outer surface of the dental implant.

According to some embodiments of the invention, the treating the outer surface of the dental implant includes completely removing threads of at least a section of threads along the outer surface of the dental implant.

According to some embodiments of the invention, the adjusting the treating tools to press onto the outer surface of the dental implant includes adjusting the adjustment nut to a specific marking on the device.

According to some embodiments of the invention, the adjusting the treating tools includes turning an adjustment nut to translate along a shaft of the device.

According to some embodiments of the invention, the adjusting the treating tools includes turning an adjustment nut to translate along a shaft of the device based on markings on the shaft.

According to some embodiments of the invention, the guide includes a first portion shaped as a cylinder having a smooth outer surface and a second portion including a thread sized and shaped to screw into a dental implant, wherein a longitudinal axis of the cylinder of the first portion is concentric with a longitudinal axis of the second portion, and a length of the second portion is selected based on length of an internal hole of the dental implant.

According to some embodiments of the invention, a length of the first portion is selected based on a length of a section of the dental implant intended for treatment.

According to some embodiments of the invention, the length of the first portion is selected to be greater than the length of the section of the dental implant intended for treatment.

According to some embodiments of the invention, the length of the first portion is selected based an X-ray image of the dental implant.

According to some embodiments of the invention, further including cooling the device with saline solution.

According to some embodiments of the invention, further including coating the treated dental implant with a material selected from a group consisting of Decapinol, and plasma.

According to an aspect of some embodiments of the present invention there is provided a method of treating peri-implantitis, including: opening gum at a location of a dental implant which exhibits peri-implantitis, removing diseased bone, inserting a guide into a dental implant, sliding an in-situ treatment tool onto the guide, rotating the in-situ treatment tool to remove an outer layer of the dental implant, and sewing gum flap over the dental implant.

According to some embodiments of the invention, and further including adjusting the in-situ treatment tool by hand using a knurled adjustment nut.

According to some embodiments of the invention, wherein the removing diseased bone comprises using the in-situ treatment tool to remove the diseased bone.

According to some embodiments of the invention, and further including producing a hole in the bone to reach bone marrow.

According to some embodiments of the invention, and further including adding bone augmentation material; and covering the bone augmentation material with a membrane.

According to some embodiments of the invention, and further including securing the membrane by screwing a screw through the membrane into the dental implant.

According to some embodiments of the invention, and further including using the in-situ treatment tool to level a bone surface at a bottom of an exposed portion of the dental implant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are X-ray images of dental implants within a jaw;

FIG. 2A is a simplified line drawing illustration of a device for treating a dental implant in-situ according to an example embodiment of the invention, located on a guide according to an example embodiment of the invention, and a dental implant;

FIG. 2B is a simplified line drawing illustration of the device of FIG. 2A and the guide of FIG. 2A, without the dental implant shown in FIG. 2A;

FIG. 2C is a simplified line drawing illustration of a generic device for treating a dental implant in-situ according to an example embodiment of the invention;

FIG. 2D is a simplified line drawing illustration of a generic device for treating a dental implant in-situ according to an example embodiment of the invention;

FIG. 2E is a simplified line drawing illustration of a generic device for treating a dental implant in-situ according to an example embodiment of the invention;

FIG. 2F is a simplified line drawing illustration of a device for treating a dental implant in-situ according to an example embodiment of the invention, located on a guide according to an example embodiment of the invention, and a dental implant;

FIG. 3 is a simplified line drawing illustration of a device for treating a dental implant in-situ according to an example embodiment of the invention;

FIG. 4 is a simplified line drawing illustration of components of a device for treating a dental implant in-situ according to an example embodiment of the invention;

FIG. 5A is a simplified line drawing illustration of components of a device for treating a dental implant in-situ according to an example embodiment of the invention;

FIG. 5B is a simplified line drawing illustration of components of a device for treating a dental implant in-situ according to an example embodiment of the invention;

FIG. 6A is a simplified line drawing illustration of components of a device for treating a dental implant in-situ according to an example embodiment of the invention;

FIGS. 6B and 6C are simplified line drawing illustrations of components of a device for treating a dental implant in-situ according to an example embodiment of the invention;

FIG. 6D is a simplified line drawing illustration of components of a device for treating a dental implant in-situ according to an example embodiment of the invention;

FIG. 6E is a simplified line drawing illustration of components of a device for treating a dental implant in-situ according to an example embodiment of the invention;

FIG. 6F is a simplified line drawing illustration of components of a device for treating a dental implant in-situ according to an example embodiment of the invention;

FIG. 7A is a simplified line drawing illustration of components of a device for treating a dental implant in-situ according to an example embodiment of the invention;

FIG. 7B is a simplified line drawing illustration of components of a device for treating a dental implant in-situ, located on a guide according to an example embodiment of the invention;

FIG. 8A is a simplified line drawing illustration of an isometric exploded view of a device for treating a dental implant in-situ according to an example embodiment of the invention, located on a guide according to an example embodiment of the invention, and a dental implant;

FIG. 8B is a simplified line drawing illustration of an isometric exploded view of a device for treating a dental implant in-situ according to an example embodiment of the invention, located on a guide according to an example embodiment of the invention, and a dental implant;

FIGS. 9A and 9B are simplified line drawing illustrations of an adjustment nut according to an example embodiment of the invention;

FIGS. 9C and 9D are simplified line drawing illustrations of an adjustment nut according to an example embodiment of the invention;

FIG. 10 is a simplified line drawing illustration of a guide for a device for treating a dental implant in-situ according to an example embodiment of the invention;

FIG. 11 is a simplified line drawing illustration of tools according to an example embodiments of the invention;

FIG. 12 is a simplified line drawing illustration of a connecting ring according to an example embodiment of the invention;

FIG. 13 is a simplified line drawing illustration of arms for extending tools according to an example embodiment of the invention;

FIG. 14 is a simplified line drawing illustration of an arm attached to a tool according to an example embodiment of the invention;

FIG. 15 is a simplified flow chart illustration of a method for treating a dental implant in-situ;

FIG. 16A is a photograph of a device for treating a dental implant in-situ according to an example embodiment of the invention, located on a guide according to an example embodiment of the invention, and a dental implant;

FIG. 16B is a simplified flow chart illustration of a method for treating a dental implant in-situ;

FIG. 17A is a simplified illustration of components of a device for treating a dental implant in-situ and a guide according to an example embodiment of the invention, located in a dental implant;

FIG. 17B is a simplified cross-sectional illustration of FIG. 17A;

FIG. 17C is a simplified illustration of a guide according to an example embodiment of the invention, located in a dental implant;

FIG. 17D is a simplified illustration of a guide according to an example embodiment of the invention;

FIG. 17E is a simplified illustration of an arm or tool of a device for treating a dental implant in-situ according to an example embodiment of the invention;

FIGS. 17F and 17G are enlarged illustrations of components of the example embodiments of FIG. 17E;

FIG. 18A is a simplified illustration of a cutting tool according to an example embodiment of the invention;

FIGS. 18B and 18C are simplified illustrations of a cutting tool according to an example embodiment of the invention;

FIG. 18D is a simplified illustration of a cutting tool according to an example embodiment of the invention;

FIG. 18E is a simplified illustration of a cutting insert according to an example embodiment of the invention;

FIG. 18F is a simplified illustration of a cutting tool according to an example embodiment of the invention;

FIG. 18G is a simplified illustration of a cutting tool according to an example embodiment of the invention;

FIGS. 19A and 19B are simplified line drawing illustrations of a device for treating a dental implant in-situ according to an example embodiment of the invention;

FIGS. 20A and 20B are simplified cross-sectional line drawing illustrations of a dental implant embedded in a patient's jaw;

FIG. 21 is a simplified flow chart illustration of a method of treating peri-implantitis;

FIG. 22 is a simplified flow chart illustration of a method of treating peri-implantitis;

FIG. 23A is a simplified line drawing of a dental implant with gums opened to expose the dental implant according to an example embodiment of the invention;

FIG. 23B is a simplified line drawing of a dental implant with gums opened to expose the dental implant, and a device for in-situ treatment of the dental implant according to an example embodiment of the invention;

FIG. 23C is a simplified line drawing of a dental implant following in-situ treatment according to an example embodiment of the invention;

FIG. 24A is a photograph of a device for treating a dental implant in-situ according to an example embodiment of the invention;

FIG. 24B is a photograph of a device for treating a dental implant in-situ according to an example embodiment of the invention; and

FIGS. 25A-25C are X-ray photographs of a dental implant in-situ according to an example embodiment of the invention.

### DESCRIPTION OF SPECIFIC EMBODIMENTS OF THE INVENTION

The present invention, in some embodiments thereof, relates to devices and methods for treating a dental implant in-situ, and, more particularly, but not exclusively, to devices and methods for treating a dental implant in-situ in response to loss of bone surrounding the dental implant.

A dental implant for which treatment is planned is an implant left in place, in-situ, in a patient's jaw.

In some embodiments a crown and/or abutment are detached from the implant, and only the implant is left in the jaw.

In some embodiments a dental practitioner optionally removes infected tissue in the vicinity of the dental implant before treating the dental implant.

An outside surface of the dental implant is optionally treated, by vigorous cleaning, or by machining and/or cutting off an outer layer.

In some embodiments threading on the outer surface of the dental implant are optionally partially removed.

In some embodiments threading on the outer surface of the dental implant are optionally completely removed, optionally leaving a smooth outer surface or a rough outer surface.

In some embodiments the outer surface of the dental implant is optionally treated or removed along a length in a range of 3-10 millimeters, or even 2-12 millimeters. In some embodiments specific sizes of components of a device for treating a dental implant in-situ are selected in order to enable treating a specific length of a dental implant. By way of some non-limiting examples, different lengths of components such as tools and/or guides, described herein, may be selected.

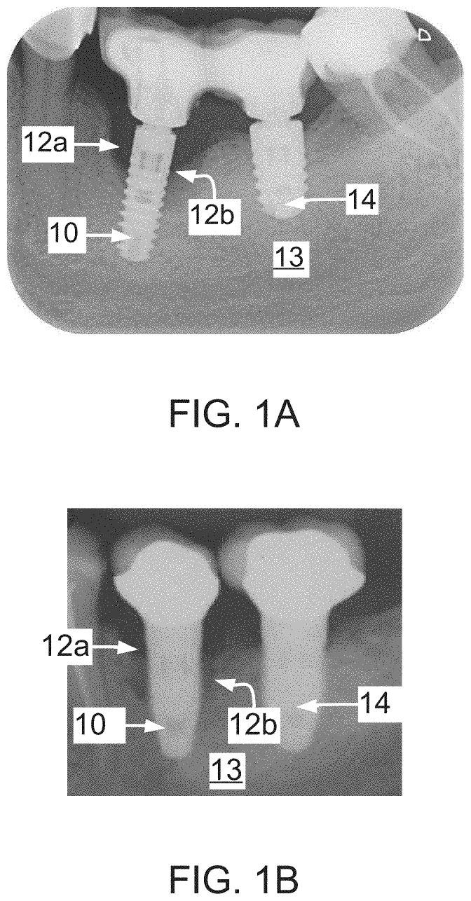

For purposes of better understanding some embodiments of the present invention, reference is first made to dental implants as shown in FIGS. 1A and 1B, which are X-ray images of dental implants within a jaw.

FIG. 1A shows two dental implants 10 14 within jaw bone 13. A first dental implant 14 appears healthy, and a second dental implant 10 appears to suffer from a disease called peri-implantitis, a progressive process, apparently due to contamination of an implant surface, where jaw bone withdraws from the dental implant 10, leaving a gap 12a 12b around the dental implant.

FIG. 1B shows two dental implants 10 14 within jaw bone 13. A first dental implant 14 appears healthy, and a second dental implant 10 appears to suffer from a disease called peri-implantitis, where jaw bone withdraws from the dental implant 10, leaving a gap 12a 12b around the dental implant.

It is noted that in some cases one dental implant may suffer from bone withdrawing from around the implant, while an adjacent implant does not suffer from bone withdrawing.

In some cases, in order to reclaim an in situ dental implant that supports a dental prosthesis, dental practitioners wish to clean the outside of the dental implant, in-situ.

Before even presenting an overview of examples aspect of the invention, an example embodiment is now described, so that some necessary and some optional components be named and briefly explained, so that the overview be understandable in context.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

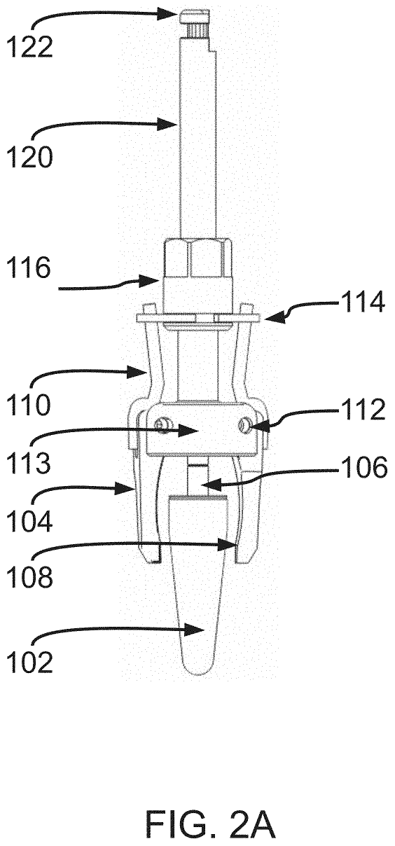

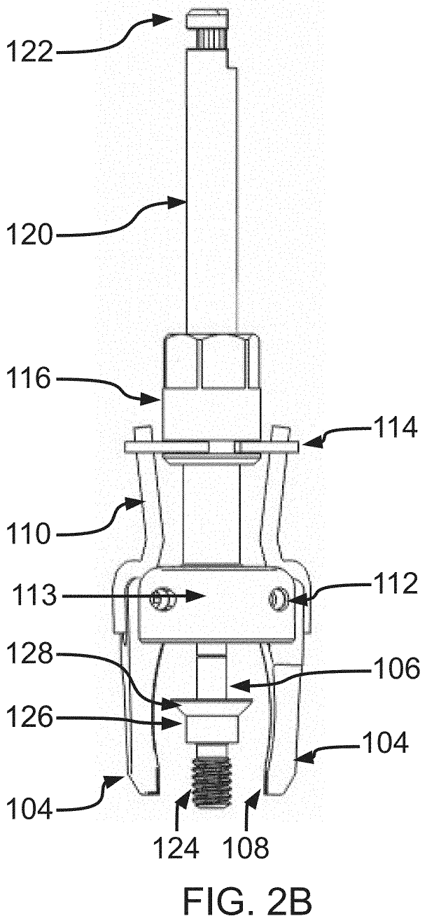

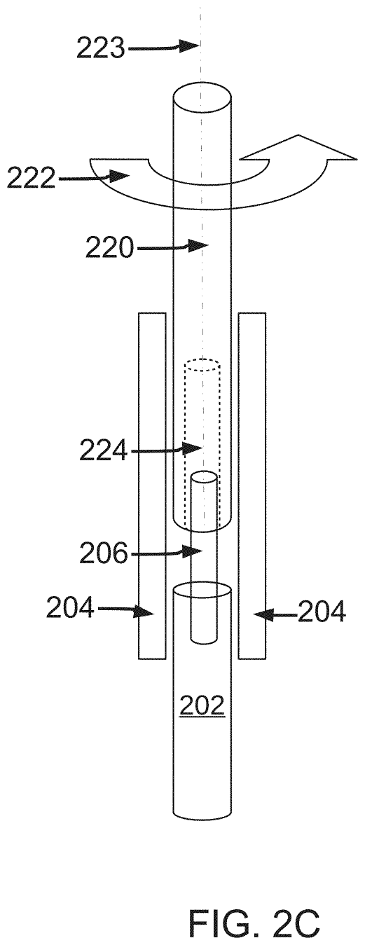

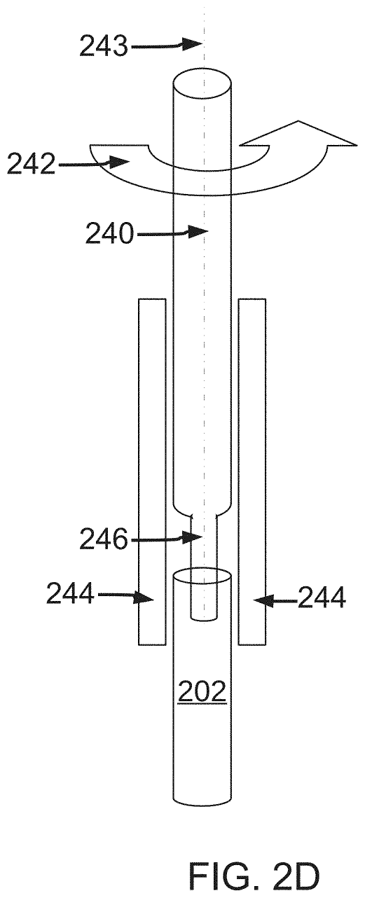

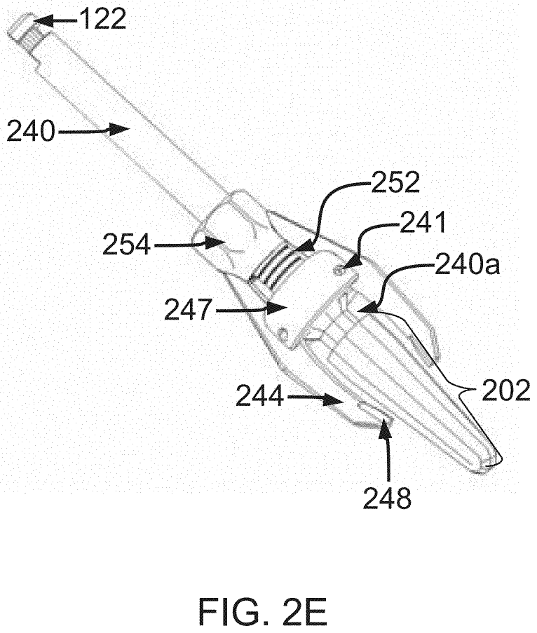

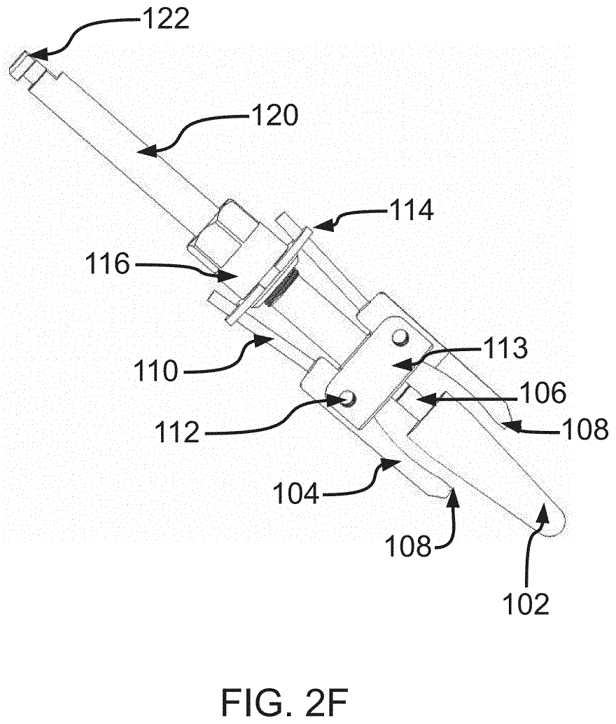

Reference is now made to FIG. 2A, which is a simplified line drawing illustration of a device for treating a dental implant in-situ according to an example embodiment of the invention, located on a guide according to an example embodiment of the invention, and a dental implant.

FIG. 2A shows the device for treating a dental implant in-situ including:

a shaft 120;

an adjustment nut 116;

a connecting ring 114; and

a tool 104, optionally including a base 110 or arm 110 which optionally serves to extend a length of the tool 104.

FIG. 2A also shows a guide 106, inserted into a dental implant 102.

In FIG. 2A an embodiment is shown where the tool 104 is mounted on a hinge 112 in a tool carrier 113.

In some embodiments some or all of the arm 110 is a spring and/or acts as a spring. By acting as a spring the arm 110 potentially keeps the tool 104 in contact with a surface of the implant 102.

In some embodiments specific sizes of components of a device for treating a dental implant in-situ are selected in order to enable treating a specific length of a dental implant. By way of some non-limiting examples, different lengths of components such as the tool 104 and/or the guide 106 may be selected.

Various drawings of the device for treating a dental implant in-situ show two tools 104. It is noted that two tools 104 are shown as a matter of a non-limiting example.

In some cases more than two tools 104 may be included in such a device, optionally arranged symmetrically around the shaft 120.

In some cases just one tool 104 may be included in such a device, configured to press against a dental implant. In some embodiments the guide 106 optionally serves to provide counter pressure to the pressure of the tool 104.

One more drawing is presented before the overview.

Reference is now made to FIG. 2B, which is a simplified line drawing illustration of the device of FIG. 2A and the guide of FIG. 2A, without the dental implant shown in FIG. 2A.

FIG. 2B shows the device of FIG. 2A and its components as described above.

FIG. 2B shows the guide 106, including optional components of the guide which were hidden in FIG. 2A, which showed the guide 106 inside a dental implant.

In some embodiments the guide 106 further includes:

Optional threading 124, a same thread as in an intended dental implant, so as to screw into the dental implant; and an optional shape corresponding to a shape of a cavity in typical dental implants, for example an optional cylindrical portion 126 above the thread 124 corresponding to a hole in the center of a typical implant; and/or an optional conical portion 128 corresponding to a conical depression in the center of a typical implant.

FIG. 2B also shows tips 108 of the example embodiment tool 104.

### Overview

In some embodiments a device is provided for treating a dental implant in-situ, treating an outside surface of a dental implant while the dental implant is in place, implanted within a patient's jaw.

An aspect of some embodiments of the invention relates to the device including a guide, which ensures that the device, which has two or more revolving arms for treating the outside surface of the dental implant, maintains a specific controlled spatial relationship to the dental implant.

In some embodiments the guide is a centering guide, which screws into a threaded hole which is present in dental implants, typically intended for an abutment and/or crown to screw therein.

In some embodiments the centering guide ensures that the device is aligned parallel to a longitudinal axis of the dental implant.

In some embodiments the guide is marked with markings along its length, so that a dental practitioner can measure or estimate a range of movement of the device along the guide.

In some embodiments the device has a rotating shaft with a central axial hole into which the guide enters. In some embodiments one or both of the guide and the central axial hole are selected so that the device can only move longitudinally and rotationally around a long axis of the dental implant along the guide to a desired depth.

In some embodiments the desired depth is selected by a dental practitioner according to a depth to which the dental implant suffers from peri-implantitis.

In some embodiments the desired depth is selected by a dental practitioner to extend beyond the depth to which the dental implant suffers from peri-implantitis, to potentially obtain healthy bone and a fresh surface of the implant.

In some embodiments the desired depth is selected by a dental practitioner according to a length of the dental implant to be treated.

In some embodiments the desired depth is selected by a dental practitioner according to X-ray imaging of the peri-implantitis, and optionally a decision to what depth the implant should be treated.

In some embodiments the guide includes a lip which sits on top of the dental implant, and extends radially further than a radius of the dental implants. The lip potentially prevents the arms of the device from being pulled upward off the dental implant, especially when the arms of the device are revolving. The lips can potentially help a dental practitioner when working on the dental implant retaining the device on the guide, and the implant, and potentially prevents having to reposition the device.

In some embodiments a tool attached to the rotating arms is shaped to engage the lip. In some embodiments a tool attached to the rotating arms includes a spring configured to engage the lip.

An aspect of some embodiments of the invention relates to the revolving arms.

In some embodiments the arms include a tool for treating the outside surface of the dental implant.

In some embodiments the arms include a tool part for treating the outside surface of the dental implant and a base part, the base part serving to extend a length of the tool.

In some embodiments the arms include a tool part for treating the outside surface of the dental implant and a base part, the base part serving to control a distance between opposing tools, potentially adjusting the device to different implant width dimensions and/or potentially controlling a strength of pressure of contact between the tool and the implant surface.

In some embodiments the base part is a spring, optionally used to press the tool against the outside of the dental implant.

In some embodiments the tool may include a cutting part, for removing a surface of the dental implant. In some embodiments the cutting part is an integral part of the tool. In some embodiments the cutting part is a hardened portion of the cutting tool.

In some embodiments, the cutting tool is rotated at a rate of 300 RPM, or in a range of 300-1000 RPM.

It is noted that a rotation rate for cutting is typically lower, often far lower, than rotation rates.

It is noted that cutting potentially generate less heat than removing the same material by grinding. Generating less heat is potentially better and safer for dental procedures and/or for the patients.

It is noted that rotating cutting tool at lower rotation rates potentially generates less heat than rotating a grinding tool at a higher rotation rate.

In some embodiments, when using a cutting tool, irrigation is optionally not used to cool the cutting surface and dental implant.

In some embodiments, when using a cutting tool, irrigation is used to remove flakes of metal removed and/or cut off from the dental implant, and/or cool the cutting surface and dental implant.

In some embodiments, grinding or polishing a dental implant is optionally performed using a burr with diamond particles rotated by a dental drill, optionally rotating at a rate in a range of 1,000-2,000 RPM.

In some embodiments, grinding or polishing a dental implant is optionally performed using a burr with diamond particles rotated by a dental turbine, optionally rotating at approximately 250,000 RPM.

In some embodiments, when using a grinding or polishing tool, irrigation is optionally used to cool the grinding surface and/or dental implant.

It is noted that grinding potentially produces small particles, like dust, which potentially makes a slurry which needs to be suctioned. However, suctioning slurry may leave slurry sticking to flesh and/or hiding in crevasses, potentially causing illness.

It is noted that cutting potentially produces larger particles which can better be suctioned. Such suctioning potentially removes cut-off flakes and potentially leaves less flakes sticking to flesh and/or flakes hiding in crevasses, potentially reducing likelihood of illness.

In some embodiments the cutting part is a cutting insert inserted into the tool. In various embodiments the cutting insert is optionally attached to the tool by one or more devices, such as, by way of some non-limiting examples, a screw, a pin going through corresponding cavities or holes in the insert and the tool, and by having the insert have a shape with a Morse angle on the outside of the insert, and a corresponding Morse angle in the tool, which can firmly hold the inset in the tool.

In some embodiments the tool may include a brush, for cleaning an outer surface of the dental implant.

In some embodiments the tool may include an abrasive or an abrasive holder, for abrading an outer surface of the dental implant.

An aspect of some embodiments of the invention relates to the cutting tool.

In some embodiments the cutting tool may be shaped to present a cutting edge and/or a cutting tip at a correct angle to the surface of the outer surface of the dental implant, so as to effect cutting away the outer surface of the dental implant.

In some embodiments the cutting tool, or at least the cutting edge or the cutting tip may be hardened to effect cutting of the outer surface of the dental implant. Proper hardening potentially makes the tool more effective, potentially lengthens the life of the tool.

In some embodiments the guide includes a lip which sits on top of the dental implant, and extends radially further than a radius of the dental implants. The lip potentially prevents the arms of the device from being pulled upward off the dental implant, especially when the arms of the device are revolving. The lips can potentially help a dental practitioner when working on the dental implant retaining the device on the guide, and the implant, and potentially prevents having to reposition the device.

In some embodiments the tool is shaped to engage the lip. In some embodiments the tool includes a spring configured to engage the lip.

In some embodiments the device includes components made of non-corrosive material suitable for sterilization. In some embodiments the entire device is made of non-corrosive material suitable for sterilization.

In some embodiments the device comprises components made of non-allergenic material.

In some embodiments the tool may include a cutting part, for removing a surface of the dental implant. In some embodiments the cutting part is an integral part of the tool. In some embodiments the cutting part is a hardened portion of the cutting tool.

In some embodiments the cutting part is a cutting insert inserted into the tool. In various embodiments the cutting insert is optionally attached to the tool y one or more devices, such as, by way of some non-limiting examples, a screw, a pin going through corresponding cavities or holes in the insert and the tool, and by having the insert have a shape with a Morse angle on the outside of the insert, and a corresponding Morse angle in the tool, which can firmly hold the inset in the tool.

An aspect of some embodiments of the invention relates to the tool and/or the arm attached to the device by a hinge.

In some embodiments the revolving arm acts as a lever, and exerting and outward force on an upper portion of the arm exerts inward force on a tool portion of the arm.

In some embodiment the device incudes an adjustment nut configured to move longitudinally along the shaft, which enables exerting force on the upper portion of the arm, potentially enabling exerting inward force on the tool portion of the arm. The inward force may be a multiple of the force on the upper portion, according to a shape of the arm, a ratio of a length of the upper portion of the arm up to the hinge to a length of the tool from the hinge on. In some embodiments the adjustments nut is threaded internally, with threads conforming to external threads formed on an outside of the shaft.

In some embodiments the adjustment nut potentially enables exerting a controlled and/or repeatable amount of force on the tool. In some embodiments the device includes marking(s) enabling to adjust the nut to a repeatable position.

In some embodiments the adjustment nut potentially enables adjusting and/or controlling a width to which the revolving arms open and close.

In some embodiments the adjustment nut potentially enables adjusting and/or controlling a depth to which the cutting tool cuts into the implant.

In some embodiments the adjustment nut can be screwed according to a marking on a shaft of the device, potentially providing reproducible, measurable depth of cutting.

An aspect of some embodiments of the invention relates to cooling the device or the tool by spraying liquid, optionally saline, on the dental implant or in a vicinity of the treatment action to the dental implant.

An aspect of some embodiments of the invention relates to a method of treating a dental implant in-situ.

In some embodiments a dental practitioner uses a device for treating a dental implant in-situ.

The dental practitioner places a guide into a hole in the dental implant, optionally screwing the guide into the implant.

The dental practitioner optionally places a hole in a shaft of the device onto the guide, and either before or after connects the shaft to a source of rotation. In some embodiments the source of rotation is a motor, or a standard dental rotating connector.

The practitioner then starts rotation of the rotating arms, and slides the rotating arms down along the dental implant, leading a tool along an outer surface of the dental implant.

In some embodiments, the dental practitioner optionally leads the tool down-and-up along the dental implant, more than once.

In some embodiments, the dental practitioner optionally leads the tool down and back up just once, and that is enough for treating the dental implant.

In some embodiments, the dental practitioner optionally adjusts an adjustment nut to set a position of a tool, such as a cutting tool, which optionally provides one or more of a controllable force of the tool on the outer surface of the dental implant; and a width of the opening of the tool, so as to limit how far into the outer surface a cutting tool may cut.

In some embodiments, the dental practitioner optionally uses a cutting tool to completely remove the thread of the outer surface of the dental implant, optionally leaving a smooth or a rough outer surface to some or all of the outer side of the dental implant, or at least some or all of an exposed portion of the dental implant.

In some embodiments a dental practitioner further coats an outside of the treated dental implant. Some non-limiting example materials used for coating include Decapinol or blood plasma.

An aspect of some embodiments of the invention relates to a design which helps keep the device on the dental implant.

In some embodiments the guide includes a lip which sits on top of the dental implant, and extends radially further than a radius of the dental implants. The lip potentially prevents the arms of the device from being pulled upward off the dental implant, especially when the arms of the device are revolving. The lips can potentially help a dental practitioner when working on the dental implant retaining the device on the guide, and the implant, and potentially prevents having to reposition the device.

An aspect of some embodiments of the invention relates to a material used to produce the device. In some embodiments, the device is constructed of. Or mostly of, stainless steel 420C, optionally tempered to a hardness of Rockwell 65, or a hardness of Rockwell 61 or more. In some embodiments, a spring is not made of the same stainless steel material as other components of the device.

Various embodiments and details are now further described.

Reference is now made to FIG. 2C, which is a simplified line drawing illustration of a generic device for treating a dental implant in-situ according to an example embodiment of the invention.

FIG. 2C shows a device for treating a dental implant in-situ including a shaft 220 and tools 204.

The device is designed to rotate 222 around its longitudinal axis 223.

In some embodiments the shaft 220 includes a hole 224 along its central axis, so as to slide the shaft 220 onto a guide 206. The guide 206 is optionally screwed into a hole in a dental implant 202.

In some embodiments the device is designed to slide the tools 204 onto an outer surface of a dental implant 202.

Reference is now made to FIG. 2D, which is a simplified line drawing illustration of a generic device for treating a dental implant in-situ according to an example embodiment of the invention.

FIG. 2D shows a device for treating a dental implant in-situ including a shaft 240 and tools 244.

The device is designed to rotate 242 around its longitudinal axis 243.

In some embodiments the shaft 240 has a diameter smaller than a diameter of a hole in a dental implant 202. In some embodiments the device is designed to slide the shaft 240 into the hole in the dental implant 202 and the tools 244 onto an outer surface of a dental implant 202.

In some embodiments the shaft 240 optionally has a tip 246 with a diameter smaller than a diameter of a hole in a dental implant 202, and a rest of the shaft 240 may or may not be with a diameter smaller than a diameter of a hole in a dental implant 202. In some embodiments the device is designed to slide the tip 246 into the hole in the dental implant 202 and the tools 244 onto an outer surface of a dental implant 202.

In some embodiments the shaft 240 optionally has a tip 246 with a diameter smaller than an inside diameter of a hole, typically a hexagonal top, which is just at a top part of a dental implant 202. In some embodiments the shaft 240 optionally has a tip 246 with a diameter equal to a distance between opposite faces of a hexagonal hole at a top part of a dental implant 202.

In some embodiments the tip 246 has a diameter not sufficient to support forces of mastication, or chewing, while still being sufficient to support guiding the device for treating a dental implant in-situ.

Reference is now made to FIG. 2E, which is a simplified line drawing illustration of a generic device for treating a dental implant in-situ according to an example embodiment of the invention;

FIG. 2E shows a device for treating a dental implant in-situ including a shaft 240 and tools 244.

In some embodiments, such as shown in FIG. 2E, the tools 244 are attached to a tool carrier 247, by pins in holes 241.

In some embodiments, such as shown in FIG. 2E, an adjustment nut 254 is connected to an outside of the shaft 240 by threads 252. The adjustment nut 254 can be rotated, moving longitudinally along the shaft 240 along the threads 252, exerting pressure on the tools 244. The adjustment nut 254 can adjust an opening or distance between tips 248 or jaws 248 of the tools 244.

In some embodiments the shaft includes a portion 240a which has a diameter smaller than a diameter of a hole in a dental implant 202. In some embodiments the device is designed to slide the portion 240a into the hole in the dental implant 202 and the tools 244 and tool tips 248 onto an outer surface of the dental implant.

Reference is now made to FIG. 2F, which is a simplified line drawing illustration of a device for treating a dental implant in-situ according to an example embodiment of the invention, located on a guide according to an example embodiment of the invention, and a dental implant.

FIG. 2F shows a different embodiment that FIG. 2A.

FIG. 2F shows the device for treating a dental implant in-situ including:

a shaft 120;

an adjustment nut 116;

a connecting ring 114; and

a tool 104, optionally including a base 110 or arm 110 which optionally serves to extend a length of the tool 104.

FIG. 2F also shows a guide 106, inserted into a dental implant 102.

In FIG. 2F an embodiment is shown where the tool 104 is mounted on a hinge 112 in a tool carrier 113.

In FIG. 2F an embodiment is shown where the arm 110 is inserted into a hole in the tool 104, while in FIG. 2A the arm 110 is attached to the arm 110 in a slot in the arm 110.

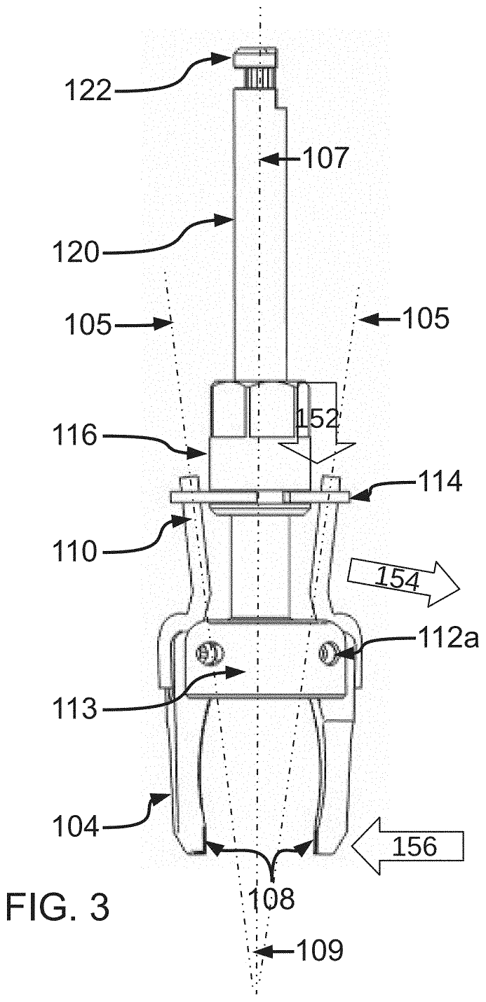

Reference is now made to FIG. 3, which is a simplified line drawing illustration of a device for treating a dental implant in-situ according to an example embodiment of the invention.

FIG. 3 shows the device for treating a dental implant in-situ, without the guide and without the dental implant.

The device of FIG. 3 includes:

a shaft 120;

an optional adjustment nut 116;

an optional connecting ring 114;

a tool 104, optionally including a base 110 or arm 110 which optionally serves to extend a length of the tool 104.

In FIG. 3 an embodiment is shown where the tool 104 is mounted on a hinge 112 in a tool carrier 113.

FIG. 3 also shows tips 108 of the example embodiment tool 104.

Some notes regarding various embodiments, including the embodiment shown in FIG. 3.

The device may include more than two revolving arms. Typically the arms are distributed equi-distantly around the shaft 120.

In some embodiments the device includes an even number of arms, arranged in opposing pairs, a first arm of the pair symmetrically across the shaft 120 from a second arm of the pair.

In some embodiments the shaft 120 includes a connector 122, to connect to a motor for providing rotation. In some embodiments the connector 122 is optionally a standard connector which fits a dental electric motor and/or a dental air turbine. The connector 122 may optionally be standard connector according to any standard used in the dental art.

In some embodiments longitudinal axes 105 of the arms 110 are at an angle 109 to a longitudinal axis 107 of the shaft 120. When the adjustment nut 116 is optionally turned and advances or retracts along the shaft 120, the arms 110 optionally move away from or toward the shaft, respectively.

In some embodiments the adjustment nut 116 potentially enables exerting a controlled and/or repeatable amount of force on the tool 104. In some embodiments the device includes marking(s) enabling to adjust the adjustment nut 116 to a repeatable position.

In some embodiments the adjustment nut 116 potentially enables adjusting and/or controlling a width to which the tool 104 opens and closes.

In some embodiments the adjustment nut 116 potentially enables adjusting and/or controlling a depth to which the tool 104 cuts.

In some embodiments the adjustment nut 116 can be screwed according to a marking (not shown) on the shaft 120 of the device, potentially providing reproducible, measurable depth of cutting.

In some embodiments a dental practitioner optionally adjusts the adjustment nut 116 until tool tips 108 touch the outer surface of the dental implant, and further until the tool tips 108 press upon the outer surface of the dental implant. The dental practitioner operates the device to cause the tools 104 to revolve, and observes that the tool tips 108 grind away the outer surface of the dental implant. If the tool tips 108 do not grind the outer surface of the dental implant, potentially producing shavings, the dental practitioner optionally stops the tools 104 from revolving and re-adjusts the adjustment nut 116 to exert more force until, when the tools 104 revolve, the tools 104 remove implant material, potentially producing shavings, from the outer surface of the dental implant.

In some embodiments, the adjustment nut 116 is moved along the shaft 120, exerting a force 152 along the shaft 120, pushing against the arms 110. The force 152 along the shaft 120 exerts a force 154 perpendicular to the arms 110. The arms 110 and the tools 104 to which they are attached act as a lever, rotating on a hinge at the hole 112a. A force 156 is exerted to push the tool tips 108 inward.

A ratio of the inward force 156 to the force 152 along the shaft 120 depends on a ratio of a distance from the hole 112a to a location where the adjust nut 116 pushed against the arms 110 to a distance from the hole 112a to the tool tips 108; and the angle 109.

In some embodiments, the inward force 156 also depends on elasticity, or springiness of the arms 110.

In some embodiments, a dental implant may have a generally conical outer surface to be ground, the top of the dental implant sometimes being wider than lower down along the implant. A dental practitioner optionally adjusts the adjustment nut 116 until tool tips 108 grind away the outer surface of the dental implant, removing a layer of the outer surface of the dental implant, optionally completely removing threads on the outer layer.

The dental practitioner slide the device down along the dental implant, which becomes narrower. The dental practitioner then optionally adjusts the adjustment nut 116 to push the tool tips 108 inward, to exert a force against the narrower portion of the dental implant, and remove material there too. The dental practitioner optionally grinds away material along the outer surface of the conical dental implant, optionally adjusting the tool tips 108 to move inward and press in as needed.

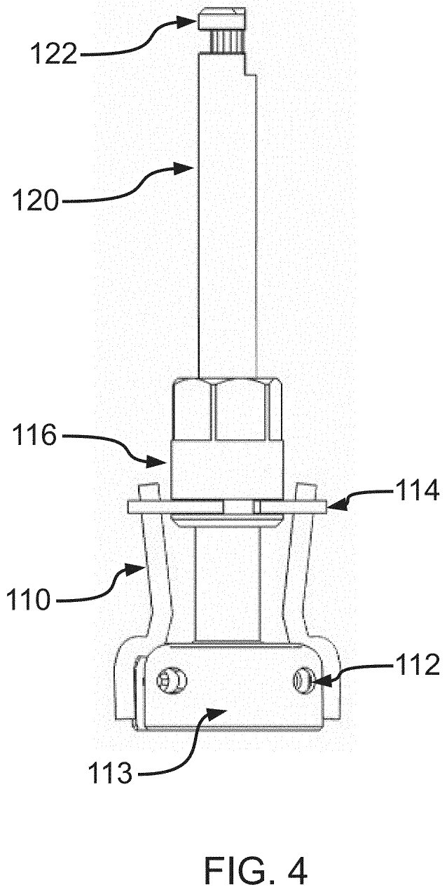

Reference is now made to FIG. 4, which is a simplified line drawing illustration of components of a device for treating a dental implant in-situ according to an example embodiment of the invention.

FIG. 4 shows the device for treating a dental implant in-situ, without the tool 104 of FIGS. 2A, 2B, 3 and other Figures described below.

FIG. 4 shows:

a shaft 120;

an optional adjustment nut 116;

an optional connecting ring 114; and

an arm 110 which optionally serves to extend a length of a tool (not shown).

In FIG. 4 an embodiment is shown where the tool 104 is not attached to the arm 110.

FIG. 4 shows a hole 112a for a hinge in a tool carrier 113 more clearly than the previous Figures.

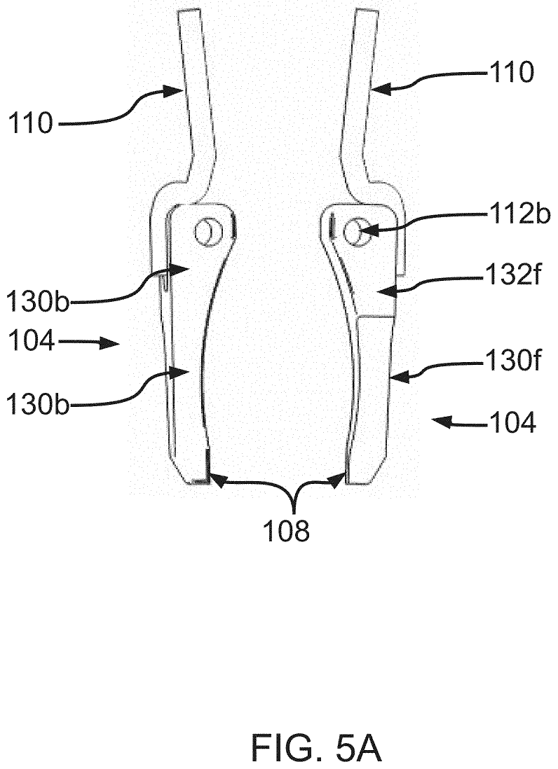

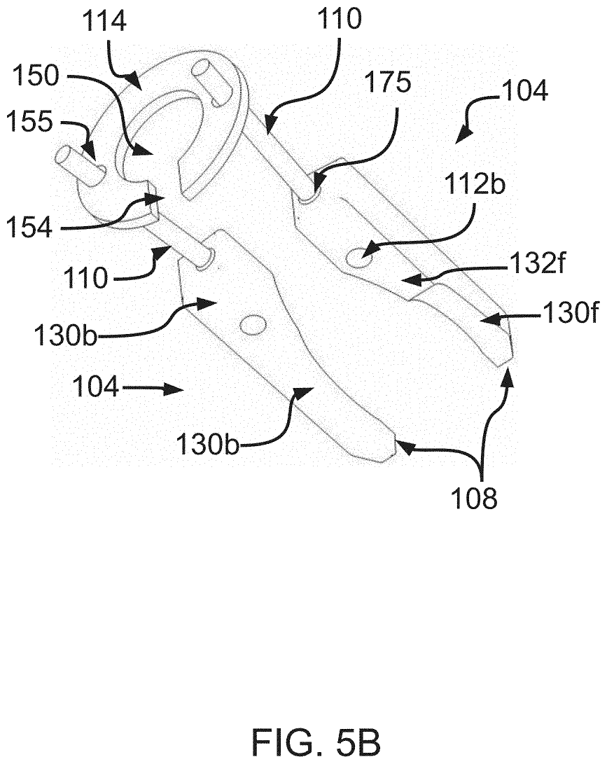

Reference is now made to FIG. 5A, which is a simplified line drawing illustration of components of a device for treating a dental implant in-situ according to an example embodiment of the invention.

FIG. 5A shows, in more detail, a tool 104, optionally including a base 110 or arm 110 which optionally serves to extend a length of the tool 104.

FIG. 5A shows one example embodiment of an arm 110, optionally comprising a spring wire.

FIG. 5A also shows one example embodiment of the tool 104 more clearly than the previous Figures. The tool 104 shown in FIG. 5A includes a hole 112b for attaching to a tool carrier (not shown).

In various embodiments the arm 110 may be a spring, or not.

In some embodiments the arm 110 and the tool 104 may formed of one piece of material.

In some embodiments the tool 104 is connected to an arm 110 by various means—by way of one non-limiting examples by a welding or a cold welding technique

In some embodiments the tool 104 is configured to grind the implant surface which is sometimes irregular, having threads.

In some embodiments, the spring arm 110 potentially provides an inward force on the tool 104, in order to provide a continuous contact with the irregular surface of the implant surface.

In some embodiments the arms 110 are optionally designed to have less mass than the tools 104.

In some embodiments the arms 110 are optionally designed to flex against the optional connecting ring 114.

The flexibility of the arms 110 is optionally designed to provide sufficient force for the tools 104 to grind the outer surface of the dental implant.

FIG. 5A also shows tips 108 of the example embodiment tool 104.

In various embodiments a length of the tool 104 from the hinge hole 112b to the tip 108 may be in a range of 6-10 mm, or even up to 20 mm. a typical value of the length may be 7 mm.

In some embodiments a forward face of the tool 104, described with reference to a direction of rotation, is optionally shaped different than a back face of the tool 104. For example, in FIG. 5A the forward face includes a flat portion 132f and an inclined portion 130f, so as to present the tips 108 correctly to an outer face of the dental implant (not shown). For example, in FIG. 5A the back face includes a flat portion 130b.

In various embodiments the tool tip 108 may be hardened to a value useful for cutting, for example to Rockwell 52, or in a range from 49 Rockwell to 65 Rockwell.

In various embodiments, the arm 110 and the tool 104 are optionally attached to each other using one of the methods described below.

Forming a tip of the arm 110 as a taper, and forming a hole in the tool 104 with a corresponding taper. In some embodiments the taper is optionally formed as a Morse taper. The arm 110 and the tool 104 are optionally connected to each other by pressing the tip of the arm 104 into the corresponding hole in the tool 104.

Forming a thread at a tip of the arm 110, and forming a threaded hole in the tool 104. The arm 110 and the tool 104 are optionally connected to each other by screwing the tip of the arm 104 into the corresponding thread in the tool 104.

Welding a tip of the arm 110 to the tool 104.

Soldering a tip of the arm 110 to the tool 104.

Reference is now made to FIG. 5B, which is a simplified line drawing illustration of components of a device for treating a dental implant in-situ according to an example embodiment of the invention.

FIG. 5B shows, in more detail, a tool 104, optionally including a base 110 or arm 110 which optionally serves to extend a length of the tool 104, and a connecting ring 114.

FIG. 5B shows an example embodiment of an arm 110, optionally comprising a spring wire.

The tool 104 shown in FIG. 5B includes a hole 112b for attaching to a tool carrier (not shown).

In various embodiments the arm 110 may be a spring, or not.

In various embodiments the arm 110 and the tool 104 may formed of one piece of material.

FIG. 5B also shows tips 108 of the example embodiment tool 104.

In various embodiments a length of the tool 104 from the hinge hole 112b to the tip 108 may be in a range of 6-10 mm, or even up to 20 mm. a typical value of the length may be 7 mm.

In some embodiments a forward face of the tool 104, described with reference to a direction of rotation, is optionally shaped different than a back face of the tool 104. For example, in FIG. 5B the forward face includes a flat portion 132f and an inclined portion 130f, so as to present the tips 108 correctly to an outer face of the dental implant (not shown). For example, in FIG. 5B the back face includes a flat portion 130b.

In various embodiments the tool tip 108 may be hardened to a value useful for cutting, for example to Rockwell 52, or in a range from 49 Rockwell to 58 Rockwell. It is noted that hardness of a typical implant metal is approximately Rockwell 30.

In various embodiments, the arm 110 and the tool 104 are optionally attached to each other using one of the methods described below.

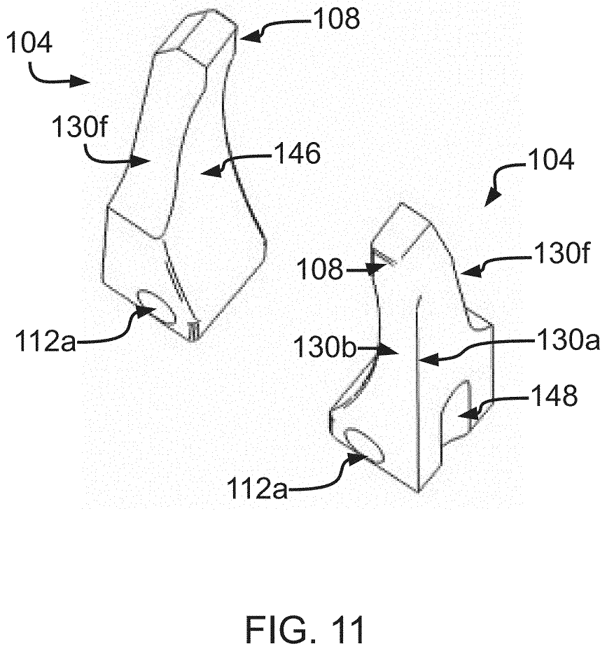

FIG. 5B shows the arm 110 inserted into a hole 175 in the tool 104, differently from, for example, the embodiments of FIG. 5A, where the arm 110 is attached to the tool 104 at a slot, such as the slot 148 shown in FIG. 11.

In some embodiments a connection of the arm 110 and the tool 104 is optionally performed by forming a tip of the arm 110 as a taper, and forming a hole in the tool 104 with a corresponding taper. In some embodiments the taper is optionally formed as a Morse taper. The arm 110 and the tool 104 are optionally connected to each other by pressing the tip of the arm 104 into the corresponding hole in the tool 104.

Other methods of attaching the arm 110 to the tool 104 are described above with reference to FIG. 5A.

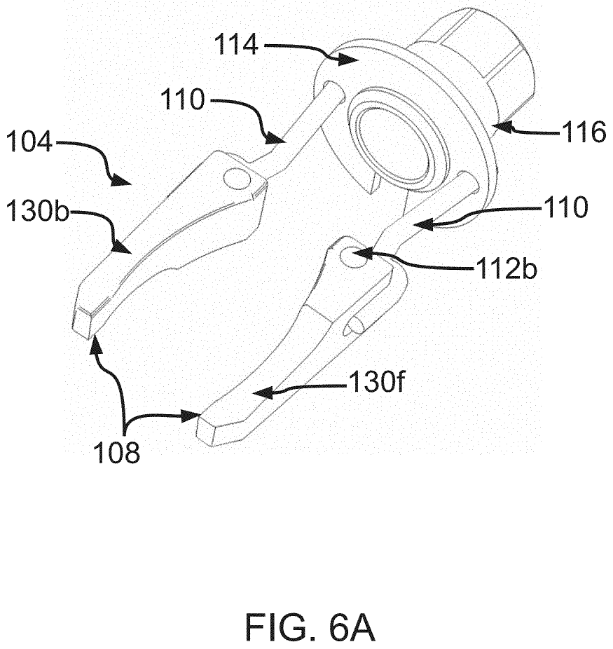

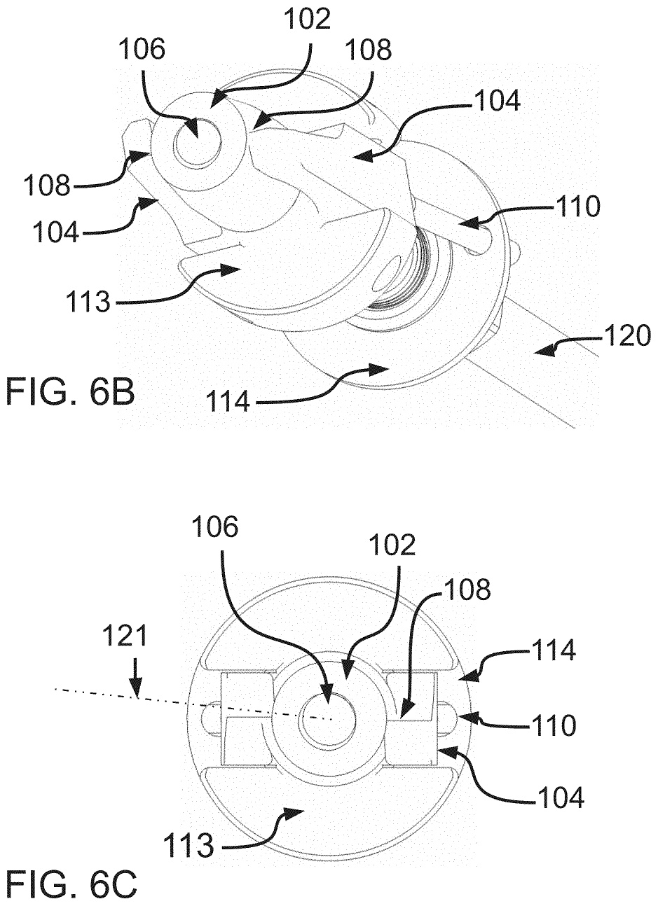

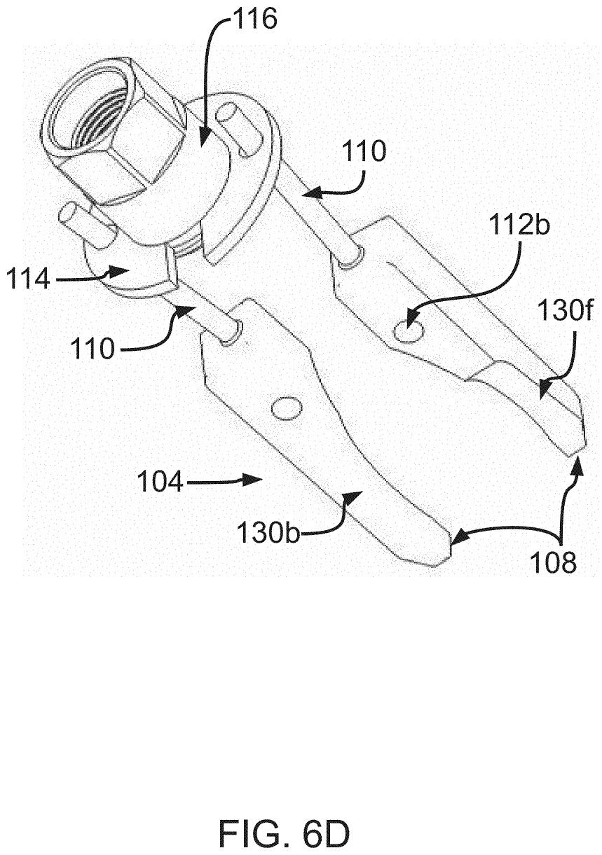

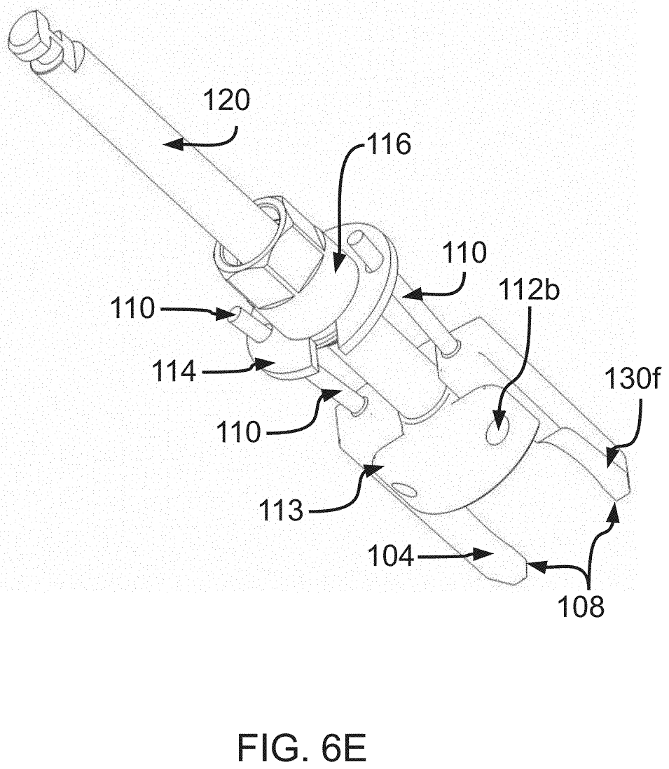

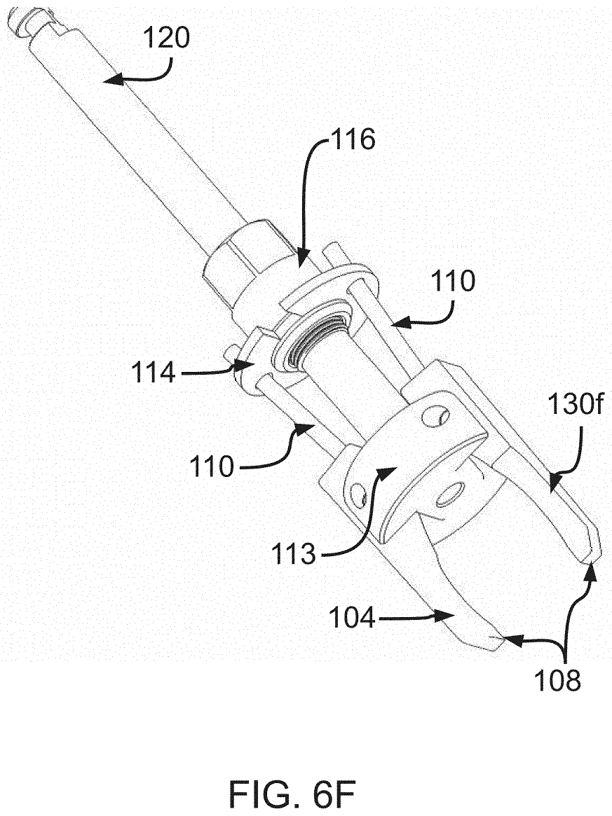

Reference is now made to FIG. 6A, which is a simplified line drawing illustration of components of a device for treating a dental implant in-situ according to an example embodiment of the invention.

FIG. 6A shows an adjusting nut 116, a connecting ring 114, arms 110, and tools 104.

FIG. 6A shows the adjusting nut 116 optionally inserted into the connecting ring 114.

FIG. 6A shows the arm 110 optionally inserted into the tool 104.

In some embodiments a forward face of the tool 104, described with reference to a direction of rotation, optionally shaped differently than a back face of the tool 104. For example, in FIG. 6A the forward face includes an inclined portion 130f, so as to present the tips 108 correctly to an outer face of the dental implant (not shown). For example, in FIG. 6A the back face includes a flat portion 130b.

In some embodiments, the adjustment nut 116 may rotate relative to the connecting ring 114, so that when the adjusting nut 116 is rotated, to adjust the device, the connecting ring 114 and the arms 110 and tools 104 do not necessarily rotate.

Reference is now made to FIGS. 6B and 6C, which are simplified line drawing illustrations of components of a device for treating a dental implant in-situ according to an example embodiment of the invention.

FIGS. 6B and 6C show illustrations which are useful for describing how a cutting tip is optionally presented to an outer surface of a dental implant.

FIG. 6B is an isometric bottom view of the device with a cutting tool against an outer surface of a dental implant.

FIG. 6C is a bottom view of the device with tips of the cutting tool against an outer surface of a dental implant.

FIGS. 6B and 6C show a guide 106 within a dental implant 102.

FIGS. 6B and 6C also show cutting tools 104, with cutting tips 108 against the outer surface of the dental implant 102.

Additional components shown include: a tool carrier 113, a tool arm 110, a connecting ring 114 and a shaft 120.

FIGS. 6B and 6C show the tips 108 of the tool 104 presented to the outer surface of the dental implant 102 at a desirable cutting angle.

FIGS. 6B and 6C show the cutting tip 108 presented at or just behind, relative to a rotation direction, of a radius 121 from a center of the dental implant, so as not to skip or slide along the outer surface of the dental implant 102.

It is noted that in some embodiments tip 108 is not necessarily presented at or just behind, relative to a rotation direction, of a radius 121 from a center of the dental implant. For example, when the tool 104 is optionally used for grinding and/or polishing, the tip 108 may be presented at, relative to a rotation direction, the radius 121 from a center of the dental implant.

Reference is now made to FIG. 6D, which is a simplified line drawing illustration of components of a device for treating a dental implant in-situ according to an example embodiment of the invention.

FIG. 6D shows an adjusting nut 116, a connecting ring 114, arms 110, and tools 104.

FIG. 6D shows the adjusting nut 116 optionally inserted into the connecting ring 114.

FIG. 6D shows the arm 110 optionally inserted into the tool 104.

In some embodiments a forward face of the tool 104, described with reference to a direction of rotation, optionally shaped differently than a back face of the tool 104. For example, in FIG. 6D the forward face includes an inclined portion 130f, so as to present the tips 108 correctly to an outer face of the dental implant (not shown). For example, in FIG. 6D the back face includes a flat portion 130b.

In some embodiments, the adjustment nut 116 may rotate relative to the connecting ring 114, so that when the adjusting nut 116 is rotated, to adjust the device, the connecting ring 114 and the arms 110 and tools 104 do not necessarily rotate.

In some embodiments a connection of the arm 110 and the tool 104 is optionally performed by forming a tip of the arm 110 as a taper, and forming a hole in the tool 104 with a corresponding taper. In some embodiments the taper is optionally formed as a Morse taper. The arm 110 and the tool 104 are optionally connected to each other by pressing the tip of the arm 104 into the corresponding hole in the tool 104.

In FIG. 6D an embodiment is shown where the arm 110 is inserted into a hole in the tool 104, while in FIG. 6A the arm 110 is attached to the arm 110 in a slot in the arm 110.

Reference is now made to FIG. 6E, which is a simplified line drawing illustration of components of a device for treating a dental implant in-situ according to an example embodiment of the invention.

FIG. 6E is a top isometric view of the components of the device.

FIG. 6E shows a shaft 120, an adjusting nut 116, a connecting ring 114, a tool carrier 113, arms 110, and tools 104.

FIG. 6E shows the adjusting nut 116 optionally inserted into the connecting ring 114.

FIG. 6E shows the arm 110 optionally inserted into the tool 104.

In some embodiments a forward face of the tool 104, described with reference to a direction of rotation, optionally shaped differently than a back face of the tool 104. For example, in FIG. 6E the forward face includes an inclined portion 130f, so as to present tips 108 of the tool 104 correctly to an outer face of the dental implant (not shown).

In some embodiments, the adjustment nut 116 may rotate relative to the connecting ring 114, so that when the adjusting nut 116 is rotated, to adjust the device, the connecting ring 114 and the arms 110 and tools 104 do not necessarily rotate.

In some embodiments a connection of the arm 110 and the tool 104 is optionally performed by forming a tip of the arm 110 as a taper, and forming a hole in the tool 104 with a corresponding taper. In some embodiments the taper is optionally formed as a Morse taper. The arm 110 and the tool 104 are optionally connected to each other by pressing the tip of the arm 104 into the corresponding hole in the tool 104.

In FIG. 6E an embodiment is shown where the arm 110 is inserted into a hole in the tool 104, while in FIG. 6A the arm 110 is attached to the arm 110 in a slot in the arm 110.

Reference is now made to FIG. 6F, which is a simplified line drawing illustration of components of a device for treating a dental implant in-situ according to an example embodiment of the invention.

FIG. 6F is a bottom isometric view of the components of the device.

FIG. 6F shows a shaft 120, an adjusting nut 116, a connecting ring 114, a tool carrier 113, arms 110, and tools 104.

FIG. 6F shows the adjusting nut 116 optionally inserted into the connecting ring 114.

FIG. 6F shows the arm 110 optionally inserted into the tool 104.

In some embodiments a forward face of the tool 104, described with reference to a direction of rotation, optionally shaped differently than a back face of the tool 104. For example, in FIG. 6F the forward face includes an inclined portion 130f, so as to present tips 108 of the tool 104 correctly to an outer face of the dental implant (not shown).

In some embodiments, the adjustment nut 116 may rotate relative to the connecting ring 114, so that when the adjusting nut 116 is rotated, to adjust the device, the connecting ring 114 and the arms 110 and tools 104 do not necessarily rotate.

In some embodiments a connection of the arm 110 and the tool 104 is optionally performed by forming a tip of the arm 110 as a taper, and forming a hole in the tool 104 with a corresponding taper. In some embodiments the taper is optionally formed as a Morse taper. The arm 110 and the tool 104 are optionally connected to each other by pressing the tip of the arm 104 into the corresponding hole in the tool 104.

In FIG. 6F an embodiment is shown where the arm 110 is inserted into a hole in the tool 104, while in FIG. 6A the arm 110 is attached to the arm 110 in a slot in the arm 110.

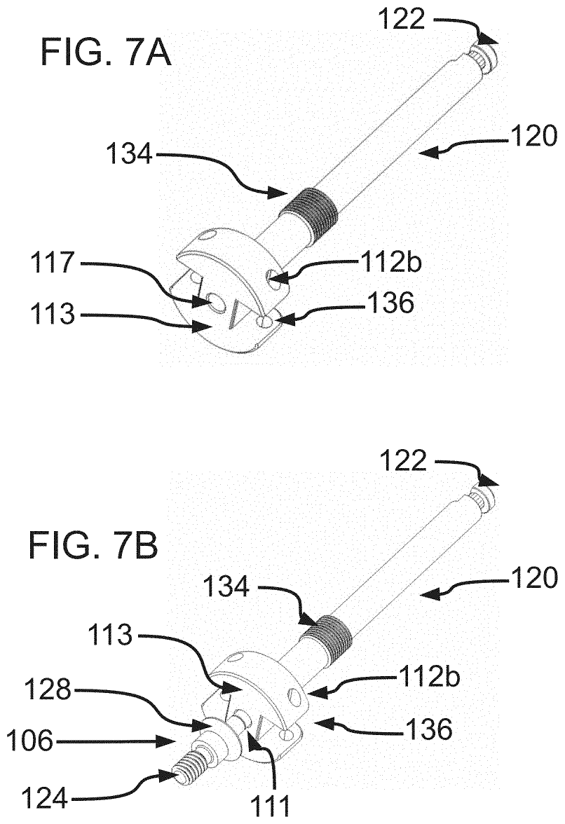

Reference is now made to FIG. 7A, which is a simplified line drawing illustration of components of a device for treating a dental implant in-situ according to an example embodiment of the invention.

FIG. 7A shows a shaft 120; threads 134 on the shaft 120 for screwing an adjustment nut (not shown) thereon; a tool carrier 113, with slots 136 and holes 112b, for supporting a rotatable hinge of a tool such as shown in other Figures shown herein.

FIG. 7A also shows a hole 117 in a center of the shaft 120, which serves for sliding over a guide, as shown, for example, in FIGS. 2A, 2B 6A, 6C and 7B.

FIG. 7A also shows an optional connector 122 for connecting the shaft 120 to a motor or other rotating device.

Reference is now made to FIG. 7B, which is a simplified line drawing illustration of components of a device for treating a dental implant in-situ, located on a guide according to an example embodiment of the invention.

FIG. 7B shows a shaft 120; threads 134 on the shaft 120 for screwing an adjustment nut (not shown) thereon; a tool carrier 113, with slots 136 and holes 112b, for supporting a rotatable hinge of a tool such as shown in other Figures shown herein.

FIG. 7B also shows a guide 106 onto which the shaft 120 is positioned. The shaft 120 is placed onto the guide 106 by inserting the guide 106 into the hole 117 (see FIG. 7A) in the shaft 120.

FIG. 7B also shows the guide 106 having threads 124 for screwing into a dental implant (not shown), and optional conical shape 128 corresponding to a conical depression in the center of a typical implant.

FIG. 7B also shows optional marking(s) 111 on the guide 106 which potentially enable a dental practitioner to estimate a position of the device relative to the dental implant.

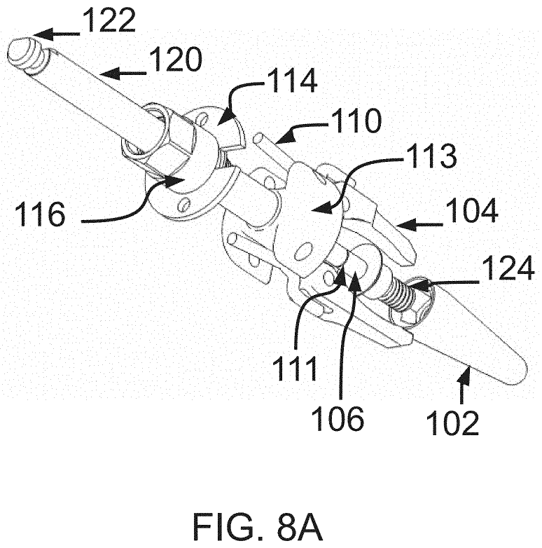

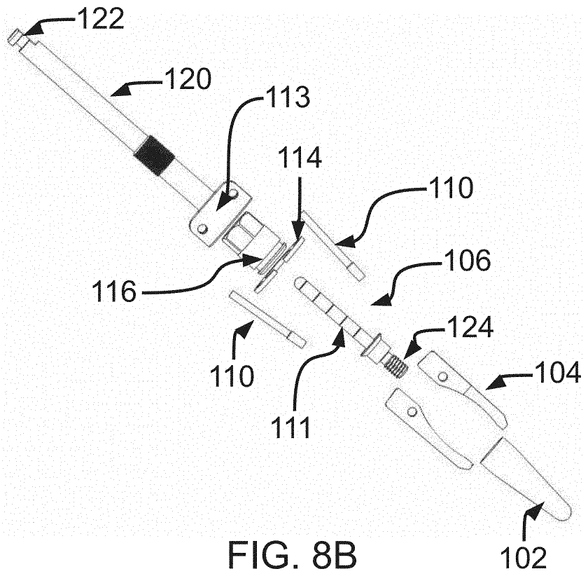

Reference is now made to FIG. 8A, which is a simplified line drawing illustration of an isometric exploded view of a device for treating a dental implant in-situ according to an example embodiment of the invention, located on a guide according to an example embodiment of the invention, and a dental implant.

FIG. 8A shows the device for treating a dental implant in-situ including:

a shaft 120 and an optional connector 122 to a dental motor/rotation mechanism;

an adjustment nut 116;

a connecting ring 114;

a tool carrier 113; and

a tool 104, optionally attached to a base 110 or arm 110.

FIG. 8A also shows a guide 106, for inserting into a dental implant 102. FIG. 8A also shows threads 124 on the guide 106, for screwing into the dental implant 102.

FIG. 8A also shows optional marking(s) 111 on the guide 106.

Reference is now made to FIG. 8B, which is a simplified line drawing illustration of an isometric exploded view of a device for treating a dental implant in-situ according to an example embodiment of the invention, located on a guide according to an example embodiment of the invention, and a dental implant.

FIG. 8B shows the device for treating a dental implant in-situ including:

a shaft 120 and an optional connector 122 to a dental motor/rotation mechanism;

an adjustment nut 116;

a connecting ring 114;

a tool carrier 113; and

a tool 104, optionally including a base 110 or arm 110 which optionally serves to extend a length of the tool 104.

FIG. 8B also shows a guide 106, for inserting into a dental implant 102. FIG. 8B also shows threads 124 on the guide 106, for screwing into the dental implant 102.

FIG. 8B also shows optional marking(s) 111 on the guide 106.

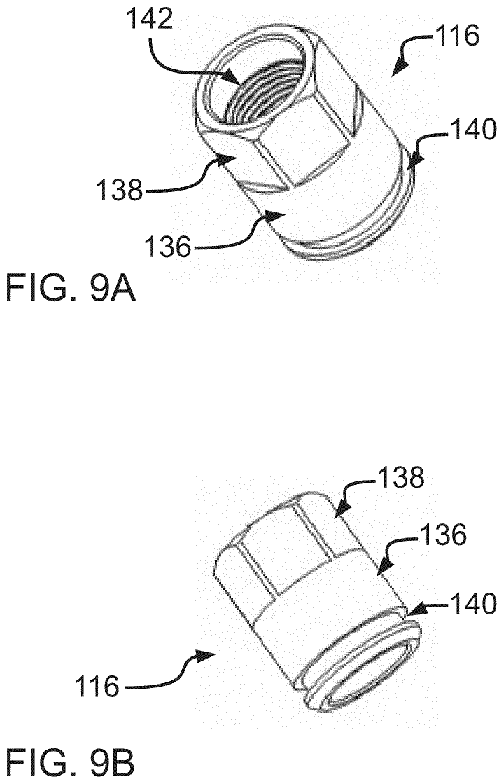

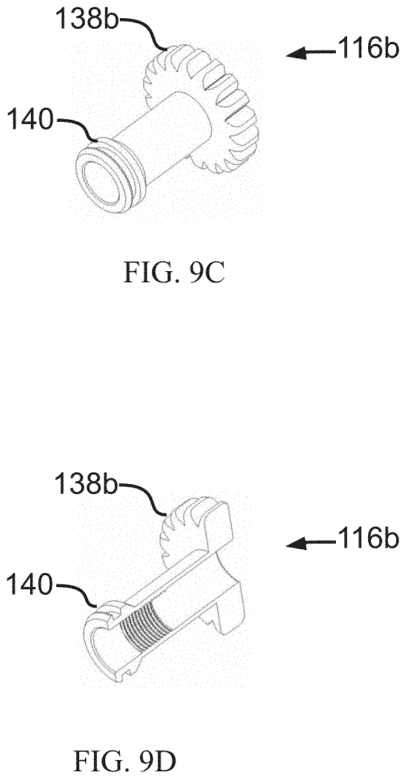

Reference is now made to FIGS. 9A and 9B, which are simplified line drawing illustrations of an adjustment nut according to an example embodiment of the invention.

FIG. 9A is an isometric top view of an adjustment nut 116, and FIG. 9B is an isometric bottom view of the adjustment nut 116.

In some embodiments the adjustment nut 116 optionally includes a depression 140 around the adjustment nut 116, into which a connection ring such as the connecting ring 114 of FIG. 8A may be placed.

In some embodiments the adjustment nut 116 optionally includes a hexagonal portion 138 so the adjustment nut 116 can rotated using a wrench.

In some embodiments (not shown) the adjustment nut 116 optionally includes a knurled portion so the adjustment nut 116 can rotated by the dental practitioner's fingers.

In some embodiments (not shown) the adjustment nut 116 optionally includes a wider (larger radius) portion so the adjustment nut 116 can rotated by the dental practitioner's fingers.

In some embodiments one portion of the adjustment nut 116 may be hexagonal 138, and one portion, for example a cylindrical portion 136, may be knurled.

Reference is now made to FIGS. 9C and 9D, which are simplified line drawing illustrations of an adjustment nut according to an example embodiment of the invention.

FIG. 9C is an isometric view of an adjustment nut 116b, and FIG. 9D is an isometric cross-sectional view of the adjustment nut 116b.

In some embodiments the adjustment nut 116b optionally includes a depression 140 around the adjustment nut 116b, into which a connection ring such as the connecting ring 114 of FIG. 8A may be placed.

In some embodiments the adjustment nut 116b optionally includes a knurled portion 138b so the adjustment nut 116b can rotated, optionally rotated by hand.

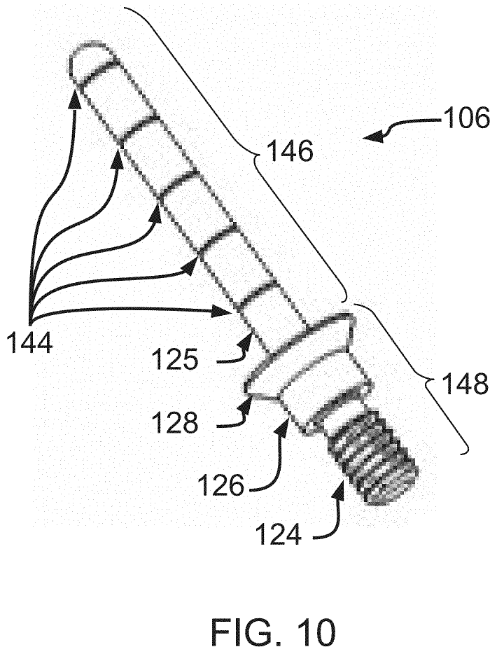

Reference is now made to FIG. 10, which is a simplified line drawing illustration of a guide for a device for treating a dental implant in-situ according to an example embodiment of the invention.

FIG. 10 shows an example embodiment of a guide 106 without other components obstructing the view.

The guide 106 includes a shaft 125 and threads 124 for screwing into a dental implant.

FIG. 10 refers to two portions of the guide 106—a first portion 146 which is intended to jut out from a dental implant when the guide 106 is screwed into the implant, and serves as an extension of the longitudinal axis of the implant, and a second portion 148 which is screwed into the implant and is intended to be within a central hole in the implant.

In some embodiments the first portion 146 includes the guide shaft 125, optionally including marking(s) 144.

In some embodiments a length of the first portion is optionally based on a length of a section of a dental implant which is intended for treating the outer surface thereof. In some embodiments the guide is selected to have a first portion with a length greater than the length of the section of the dental implant which is intended for treatment. In some embodiments the guide is selected to have a first portion with a length equal to the length of the section of the dental implant which is intended for treatment.

In some embodiments the guide is selected to have a first portion with a length based on the length of the section of the dental implant which is intended for treatment, based on an X-ray image of the dental implant, optionally showing an extent of peri-implantitis.

In some embodiments the second portion 148 includes the threads 124, an optional cylindrical section 126

Various embodiments of the guide 106 may include various threads 124, to be able to screw into various threads of various dental implants.

In some embodiments the second portion 148 may optionally include sections shaped to correspond to a shape of a cavity in typical dental implants, for example an optional cylindrical portion 126 above the thread 124 corresponding to a hole in the center of a typical implant; and/or an optional conical portion 128 corresponding to a conical depression in the center of a typical implant.

In some embodiments a length of the second portion 148 may be equal to a depth of an implant hole. By way of some non-limiting examples, a length in a range between 8-13 mm, and even 5-20 mm.

Reference is now made to FIG. 11, which is a simplified line drawing illustration of tools according to an example embodiments of the invention.

FIG. 11 is a drawing of example embodiments of cutting tools 104.

It is noted that in some embodiments other types of tools 104 may be used, such as brushes; tools with an abrasive end; or tools for mounting abrasives or cutting tools thereon.

The cutting tool 104 of FIG. 11 shows specific features of an example embodiment. The features include:

a hole 112a for a hinge in a tool carrier;

an optional slot 148 for optionally attaching an arm such as the arm 110 shown in FIG. 8A;

an optional concave surface 146, shaped so that a cutting tip 108 will contact an outer surface of a dental implant without the surface 146 contacting the dental implant surface; and

an optional inclined portion 130f and/or back portion 130b shaped to taper the tool from a wider base to a thinner tip 108.

In some embodiment an edge 130a of the tool 104 may optionally be shaped at an approximately 90 degree angle.

The edge 130a is an external edge, relative to the tool rotation around a dental implant.

In some embodiments, when the tool rotates in the device, the edge 130a is optionally used to scrape bone surface in a vicinity of the dental implant.

In some embodiments the optional scraping of the bone potentially eliminates diseased bone, and/or potentially encourages bone growth.

In some embodiments, a thickness or with of the tool 104 is optionally selected according to a width of space between a dental implant and surrounding bone—either with intent to scrape bone, or with intent NOT to scrape bone, or WITH intent to scrape bone. In some embodiments, the thickness or with of the tool 104 is optionally selected based on X-ray images of the dental implant in-situ, and measurement or estimation of the width of space between the dental implant and the surrounding bone.

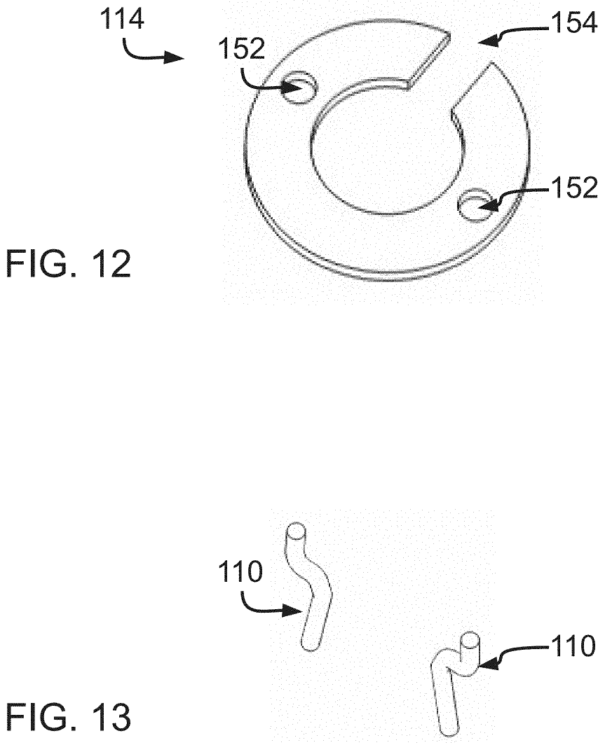

Reference is now made to FIG. 12, which is a simplified line drawing illustration of a connecting ring according to an example embodiment of the invention.

FIG. 12 shows a connecting ring 114 having two holes 152. The holes 152 are for inserting an arm, such as the arm 110 of FIG. 8A, or a tool, such as the tool 104 of FIG. 8A, therethrough. In some embodiments there may be more than two tools or arms, and there are a corresponding number of holes 152 in the connecting ring 114.

FIG. 12 also shows a slot 154. In some embodiments the slot 154 is used to slide the connecting ring 154 over an adjustment nut, such as the adjustment nut 116 of FIG. 8A. In some embodiments the slot 154 is used to slide the connecting ring 154 over a shaft, such as the shaft 120 of FIG. 8A.

In some embodiments the connecting ring 114 may not have a slot 154, and may be slid onto the adjustment nut or the shaft.

Reference is now made to FIG. 13, which is a simplified line drawing illustration of arms for extending tools according to an example embodiment of the invention.

FIG. 13 is an isometric drawing of two arms 110, situated in space as they would be situated in a device for treating a dental implant in-situ, yet without any other components of the device.

It is noted that in some embodiments, a device for treating a dental implant in-situ does not include arms, just a tool such as the tool 104.

In some embodiments, a device for treating a dental implant in-situ does include arms.

In some embodiments the arms 110 may be shaped as a wire, that is, have a circular or elliptical cross section. In some embodiments the cross section may be different, for example rectangular.

In some embodiments the arms 110 may be bent as shown in FIG. 13. In some embodiments the arms 110 may be straight.

In some embodiments the arms 110 may be made of a spring material.

In some embodiments the arms 110 may be made substantially stiff, hardly flexing even under conditions in which they are being used.

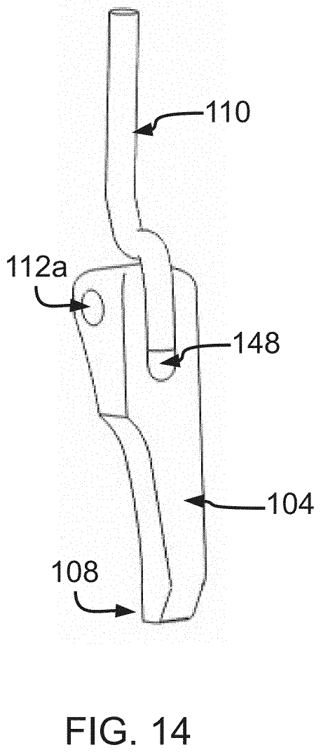

Reference is now made to FIG. 14, which is a simplified line drawing illustration of an arm attached to a tool according to an example embodiment of the invention.

FIG. 14 shows an arm 110 such as the arm 110 of FIG. 8A, attached to a tool 104 such as the tool 104 of FIG. 8A.

In FIG. 14 the arm 110 is shown attached to the tool 104 at a slot 148 in the tool 104.

FIG. 14 also shows a hole 112a for passing a pin (not shown) therethrough, to connect to a tool carrier, such as the tool carrier 113 shown in FIG. 8A.

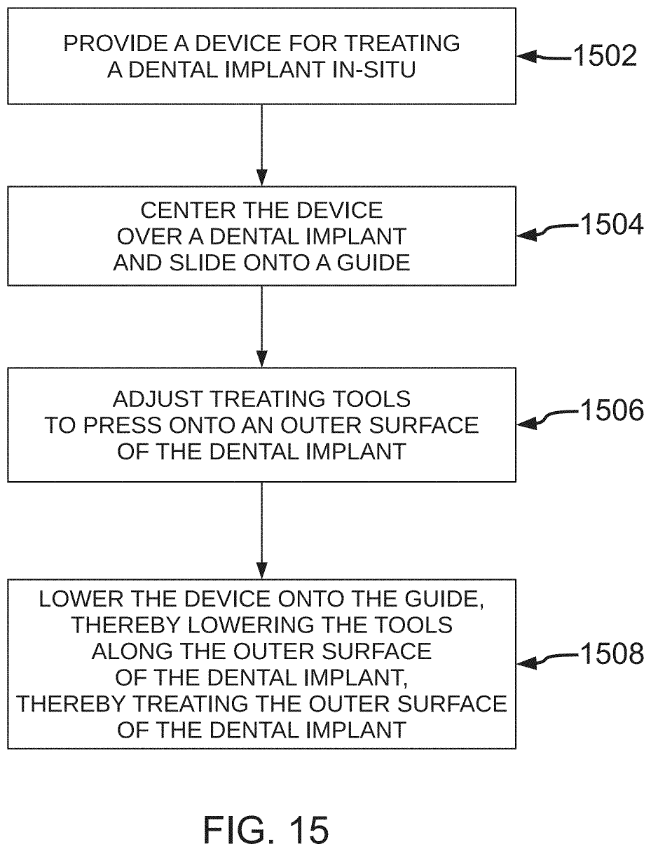

Reference is now made to FIG. 15, which is a simplified flow chart illustration of a method for treating a dental implant in-situ.

The method of FIG. 15 includes:

providing a device for treating a dental implant in-situ (1502);

centering the device over a dental implant and sliding onto a guide (1504);

adjusting treating tools to press onto an outer surface of the dental implant (1506); and

lowering the device onto the guide, thereby lowering the tools along the outer surface of the dental implant, thereby treating the outer surface of the dental implant (1508).

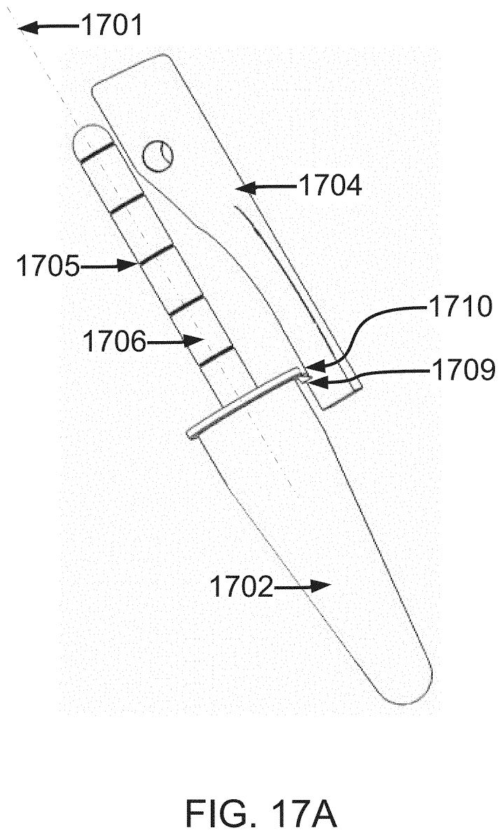

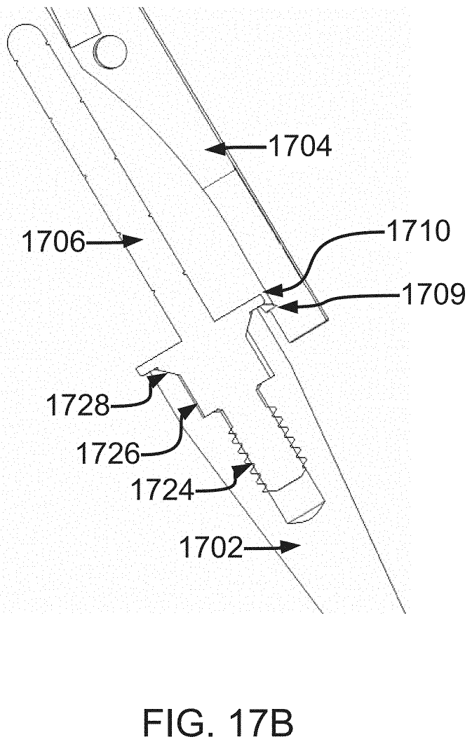

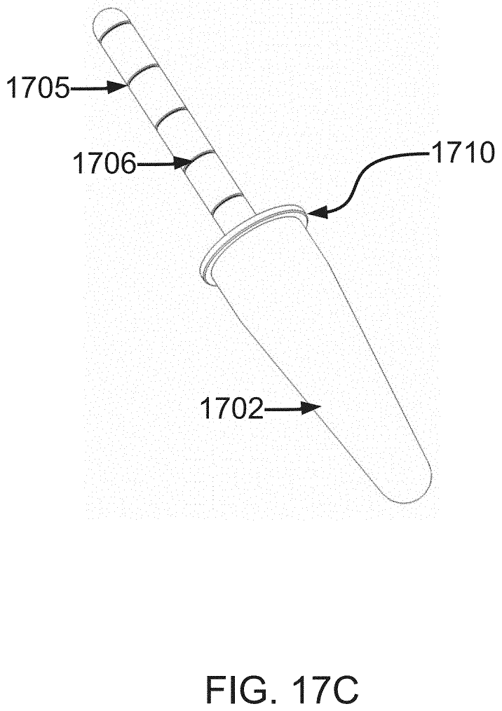

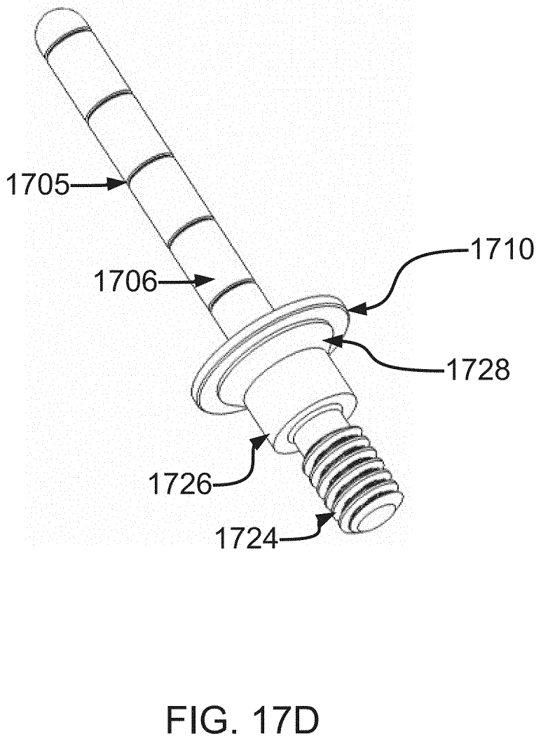

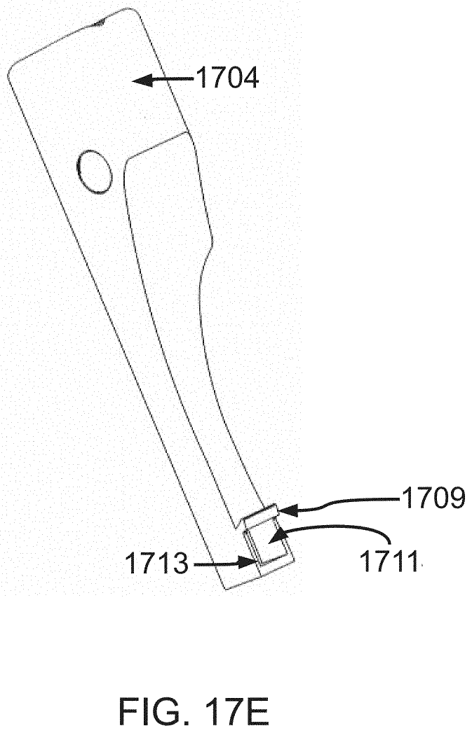

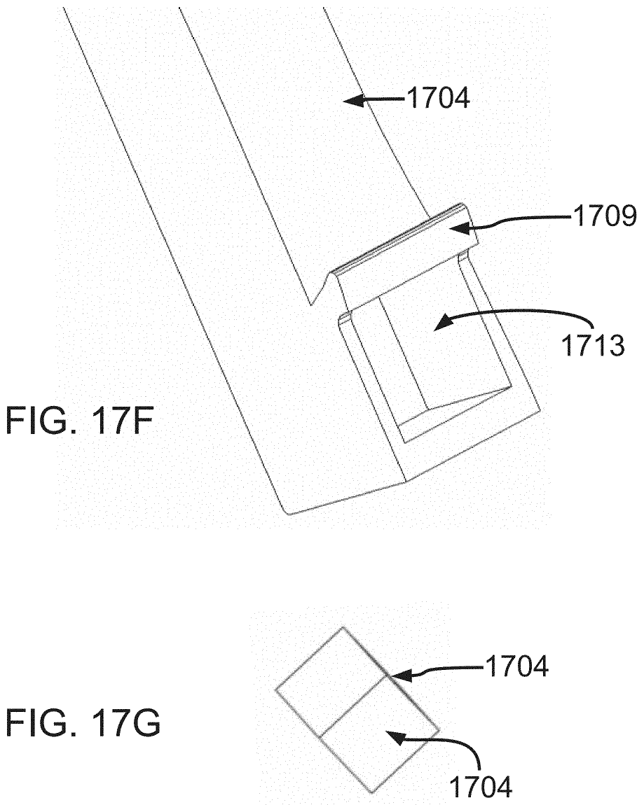

Reference is now made to FIG. 17A, which is a simplified illustration of components of a device for treating a dental implant in-situ and a guide according to an example embodiment of the invention, located in a dental implant.

FIG. 17A shows a guide 1706 inserted into a dental implant 1702, and just one arm or tool 1704 of the example embodiment device, in the interest of clarity.

The guide 1706 includes a lip 1710, or extension, extending radially further than a radius of a top of the dental implant 1702. FIG. 17A also shows optional markings 1705 on the guide 1706.

In some embodiments the tool 1704 includes a ledge 1709 jutting toward a central axis 1701 of the guide 1706. The ledge 1709 potentially prevents the tool 1704 from being inadvertently pulled upward off the dental implant 1702.

In some embodiments a cutting tool is attached to or built into the tool 1704, and optionally juts out from the tool 1704, so as to potentially prevent the tool 1704 from being inadvertently pulled upward off the dental implant 1702.

In some embodiments an adjustment nut (not shown in FIG. 17A) such as the above-mentioned adjustment nut 116 adjusts how far the tool 1704 is pushed inward toward the axis 1701, potentially adjusting the ledge 1709 to be further inward than the lip 1710, potentially prevents the tool 1704 from being inadvertently pulled upward off the dental implant 1702

Reference is now made to FIG. 17B, which is a simplified cross-sectional illustration of FIG. 17A.

FIG. 17B shows the guide 1706 inserted into the dental implant 1702, and the arm or tool 1704 of the example embodiment device.

FIG. 17B shows more details of the guide 1706, namely an optional threading 1724, an optional shape corresponding to a shape of a cavity in typical dental implants, for example an optional cylindrical portion 1726 above the thread 1724 corresponding to a hole in the center of a typical implant; and/or an optional conical portion 1728.

FIG. 17B shows the lip 1710, engaged with the ledge 1709 of the tool 1704.

Reference is now made to FIG. 17C, which is a simplified illustration of a guide according to an example embodiment of the invention, located in a dental implant.

FIG. 17C shows a guide 1706 inserted into a dental implant 1702, and just one arm or tool 1704 of the example embodiment device, in the interest of clarity.

The guide 1706 includes a lip 1710, or extension, extending radially further than a radius of a top of the dental implant 1702. FIG. 17C also shows optional markings 1705 on the guide 1706.

Reference is now made to FIG. 17D, which is a simplified illustration of a guide according to an example embodiment of the invention.

FIG. 17D shows details of a guide 1706, namely an optional threading 1724, an optional shape corresponding to a shape of a cavity in typical dental implants, for example an optional cylindrical portion 1726 above the thread 1724 corresponding to a hole in the center of a typical implant; and/or an optional conical portion 1728, and an optional lip 1710 or extension, sized and shaped to extend radially further than a radius of a top of a dental implant 1702.

FIG. 17D also shows optional markings 1705 on the guide 1706.

Reference is now made to FIG. 17E, which is a simplified illustration of an arm or tool of a device for treating a dental implant in-situ according to an example embodiment of the invention.

FIG. 17E shows an example embodiment tool 1704 of an example embodiment device for treating a dental implant in-situ.

In some embodiments the tool 1704 includes a ledge 1709. In some embodiments the ledge 1709 potentially prevents the tool 1704 from being inadvertently pulled upward off a dental implant.

In some embodiments the tool 1704 includes an optional cavity 1713, into which an optional spring 1711 is optionally inserted, so that it is a sprint 1711 rather than a ledge 1709 which juts out to engage a lip of a guide to potentially prevent the tool 1704 from being inadvertently pulled upward off a dental implant.

Reference is now made to FIGS. 17F and 17G, which are enlarged illustrations of components of the example embodiments of FIG. 17E.

FIG. 17F shows the tool 1704 including the optional cavity 1713.

FIG. 17G shows the spring 1711. In some embodiments the spring 711 is a flat spring. In some embodiments the spring 1771 is a flat spring including at least one bend 1714, as shown in FIG. 17G.

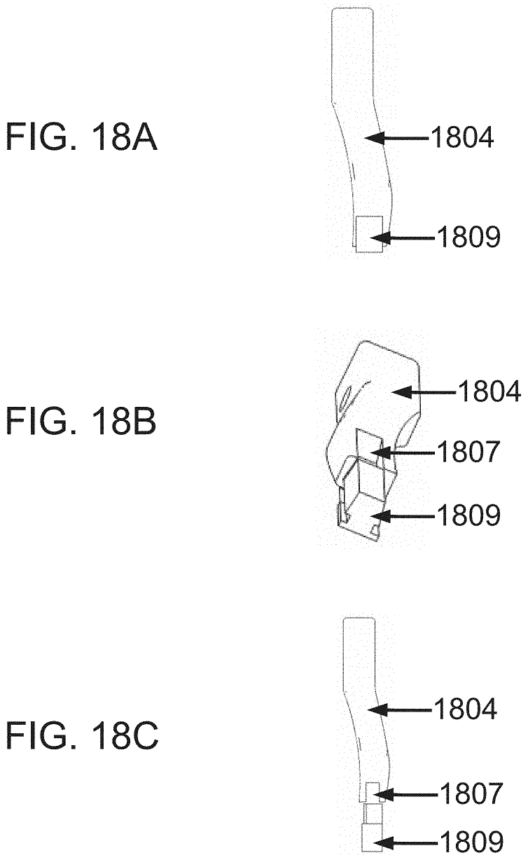

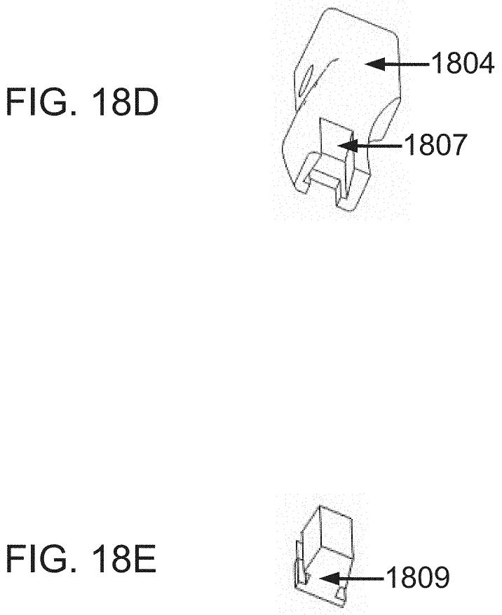

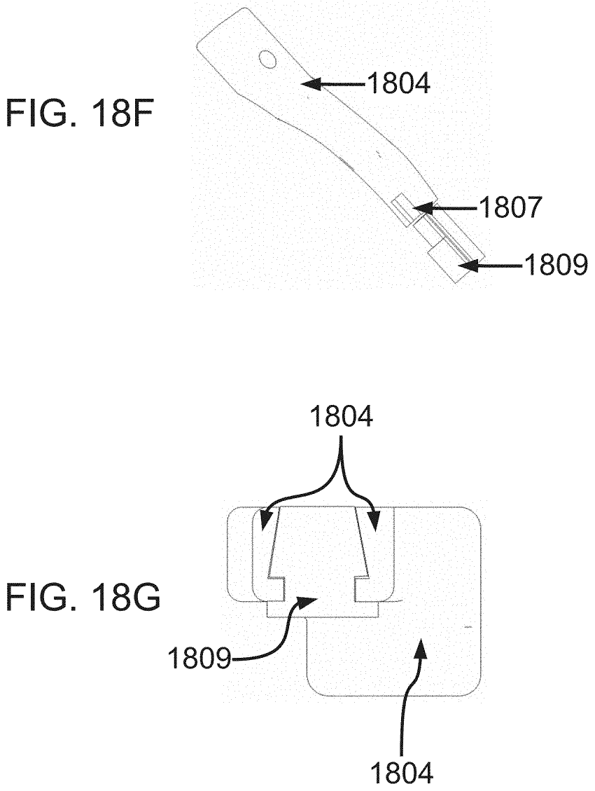

Reference is now made to FIG. 18A, which is a simplified illustration of a cutting tool according to an example embodiment of the invention.

FIG. 18A is a side view of a cutting tool 1804 which includes a cutting insert 1809. In some embodiments the cutting insert 1809 is optionally made of a harder material than the tool 1804.

In some embodiments the cutting insert 1809 is replaced in the cutting tool 1804 after one or more uses, and/or between different patients.

In some embodiments the cutting insert 1809 is attached to the cutting tool 1804 by a screw (not shown). In some embodiments the cutting insert 1809 is attached to the cutting tool 1804 by a pin (not shown) inserted through a hole (not shown) in the cutting insert 1809 and a corresponding hole (not shown) in the cutting tool 1804. In some embodiments the cutting insert 1809 is attached to the cutting tool 1804 by being shaped with at least two planes at a Morse angle, and the cavity 1807 being shaped with corresponding planes at the Morse angle.

In some embodiments the cutting insert 1809 is optionally made of a material such as tungsten or zirconium.

In some embodiments the cutting insert 1809 is optionally welded to tool 1804.

Reference is now made to FIGS. 18B and 18C, which are simplified illustrations of a cutting tool according to an example embodiment of the invention.

FIG. 18B is an isometric bottom view of a cutting tool 1804 which includes a cutting insert 1809.

FIG. 18C is a side view of the cutting tool 1804 and the cutting insert 1809.

FIGS. 18B and 18C show the cutting insert 1809 pulled partly out of a cavity 1807 shaped and sized to accommodate the cutting insert 1809.

Reference is now made to FIG. 18D, which is a simplified illustration of a cutting tool according to an example embodiment of the invention.

FIG. 18D is an isometric bottom view of a cutting tool 1804 which includes a cavity 1807 shaped to accommodate a cutting insert (not shown in FIG. 18D).

Reference is now made to FIG. 18E, which is a simplified illustration of a cutting insert according to an example embodiment of the invention.

FIG. 18E is an isometric view of a cutting insert 1809.

Reference is now made to FIG. 18F, which is a simplified illustration of a cutting tool according to an example embodiment of the invention.

FIG. 18F is a side view of a cutting tool 1804 which includes a cutting insert 1809. FIG. 18F shows the insert 1809 pulled partially out of a cavity 1807 in the cutting tool 1804.

Reference is now made to FIG. 18G, which is a simplified illustration of a cutting tool according to an example embodiment of the invention.

FIG. 18G is a bottom view of a cutting tool 1804 which includes a cutting insert 1809.

FIG. 18G shows how side walls 1804 of a cavity in the tool 1804 are shaped to accommodate and conform to a shape of the insert 1809.

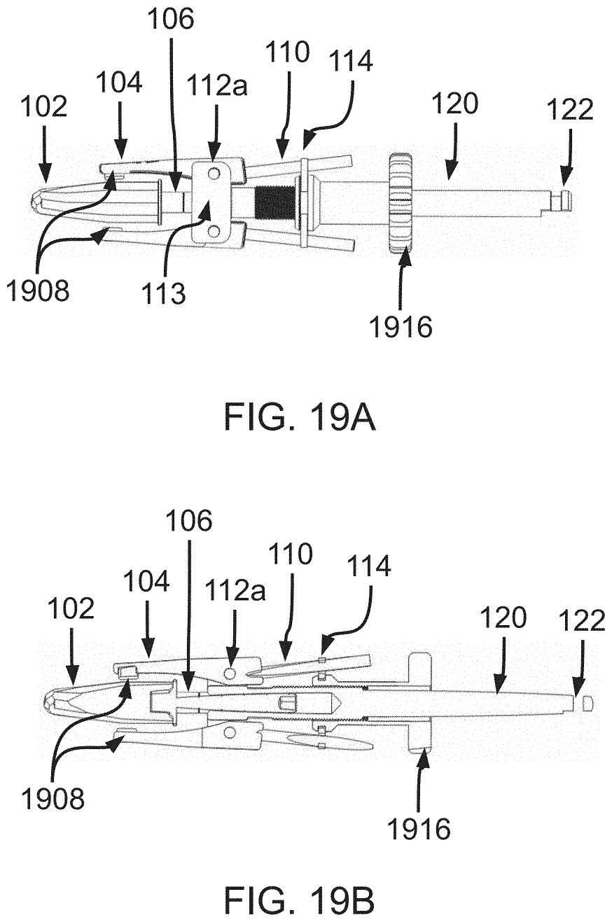

Reference is now made to FIGS. 19A and 19B, which are simplified line drawing illustrations of a device for treating a dental implant in-situ according to an example embodiment of the invention.

FIGS. 19A and 19B show the device for treating a dental implant in-situ, including a guide and a dental implant.

The device of FIGS. 19A and 19B includes:

a shaft 120;

an optional adjustment nut 1916;

an optional connecting ring 114;

a tool 104, optionally including a base 110 or arm 110 which optionally serves to extend a length of the tool 104.

In FIGS. 19A and 19B an embodiment is shown where the tool 104 is mounted on a hinge 112a in a tool carrier 113.

FIGS. 19A and 19B also show tips 1908 mounted on the example embodiment tool 104.

In some embodiments the tips 1908 are cutting tools, optionally made of a material suitable for cutting a dental implant. In some embodiments, the tips 1908 optionally have a Rockwell hardness greater than 50. In some embodiments, the tips 1908 optionally include a material such as Tungsten and Zirconium.

In some embodiments the tips 1908 are optionally grinding and/or polishing tools, optionally made of a material suitable for grinding or polishing a dental implant. In some embodiments, the tips 1908 optionally include an abrasive suitable for grinding or polishing a material such as a dental implant, for example diamond abrasive.

Some notes regarding various embodiments, including the embodiment shown in FIGS. 19A and 18B, are listed below.

In some embodiments the adjustment nut 1916 is optionally a knurled nut, potentially removing a need to manipulate the adjustment with a tool, and potentially enabling a dentists to adjust the knurled adjustment nut by hand.

In some embodiments the adjustment nut 1916 can be screwed according to a marking (not shown) on the shaft 120 of the device, potentially providing a reproducible, measurable depth of cutting.

In some embodiments, a method is provided to treat peri-implantitis.

Peri-implantitis is a dental disease resulting in inflammation of the soft and/or hard gum tissues surrounding a dental implant. In some cases, peri-implantitis is associated with loss of bone structure around an inflamed gum supporting the tooth implant.

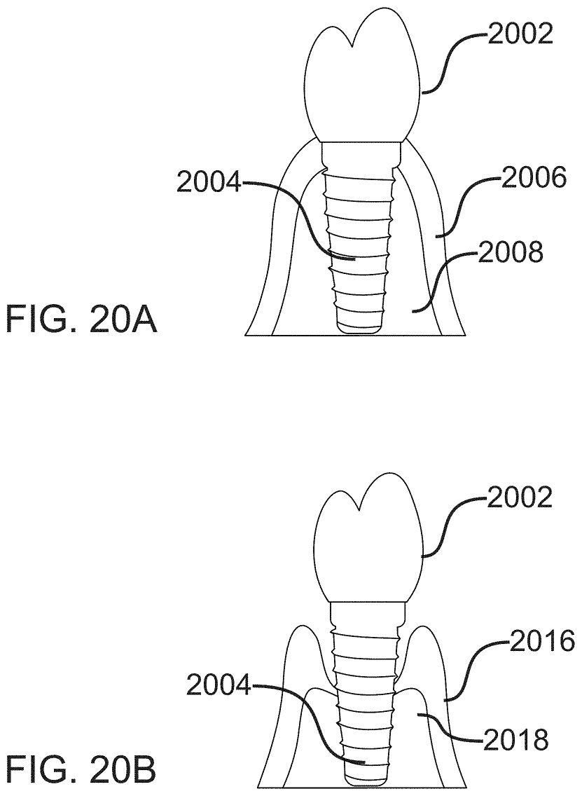

Reference is now made to FIGS. 20A and 20B, which are simplified cross-sectional line drawing illustrations of a dental implant embedded in a patient's jaw.

FIG. 20A shows a healthy jaw bone 2008, a healthy gum 2006, surrounding a dental implant 2004 and a crown 2002.

FIG. 20B shows a typical case of peri-implantitis, showing a diseased jaw bone 2018, a diseased gum 2016, surrounding a dental implant 2004 and a crown 2002.

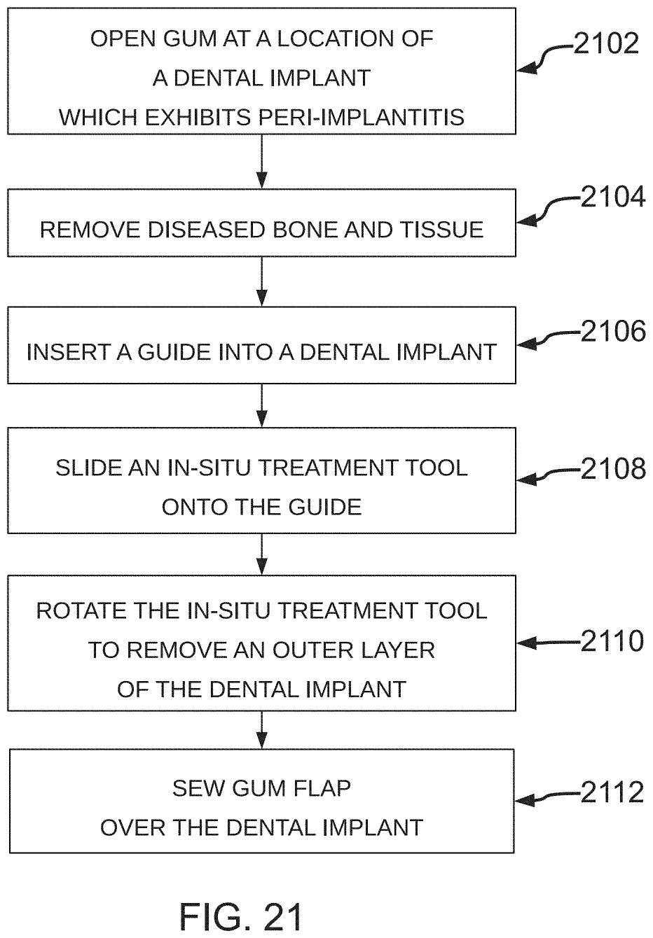

Reference is now made to FIG. 21, which is a simplified flow chart illustration of a method of treating peri-implantitis.

The method of FIG. 21 includes:

opening gum at a location of a dental implant which exhibits peri-implantitis (2102);

removing diseased bone and tissue (2104);

inserting a guide into a dental implant (2106);

sliding an in-situ treatment tool onto the guide (2108);

rotating the in-situ treatment tool to remove an outer layer of the dental implant (2110); and

sewing gum flap over the dental implant (2112).

In some embodiments, the rotating the in-situ treatment tool to remove an outer layer of the dental implant optionally includes using the in-situ treatment tool to remove bone.

In some embodiments, the in-situ treatment tool is used to remove diseased tissue, such as diseased tissue and/or diseased bone, in addition to or instead of the above-mentioned removing diseased bone and tissue (2104).

In some embodiments, the in-situ treatment tool is used to remove an additional amount of healthy bone, optionally ensuring that all the diseased bone has been removed.

In some embodiments, the in-situ treatment tool is used to remove an additional amount of healthy bone, optionally producing a flat bone surface.

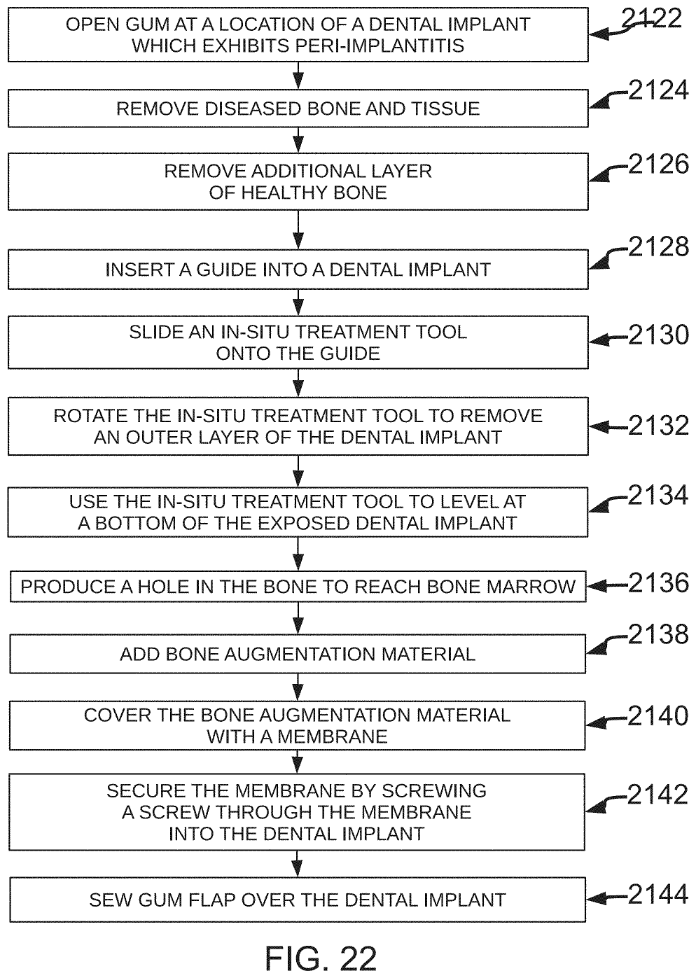

Reference is now made to FIG. 22, which is a simplified flow chart illustration of a method of treating peri-implantitis.

The method of FIG. 22 includes:

opening gums at a location of a dental implant which exhibits peri-implantitis (2122);

removing diseased bone and tissue (2124);

optionally removing an additional layer of healthy bone, to make sure all diseased bone has been removed (2126);

inserting a guide into a dental implant (2128);

sliding an in-situ treatment tool onto the guide (2130);

rotating the in-situ treatment tool to remove an outer layer of the dental implant (2132);

optionally using the in-situ treatment tool to level at a bottom of the exposed dental implant (2134);

optionally producing a hole in the bone to reach bone marrow (2136);

optionally adding bone augmentation material to enable augmenting the bone (2138);

optionally covering the bone augmentation material with a membrane (2140);

optionally securing the membrane by screwing a screw through the membrane into the dental implant (2142); and

sewing gum flap over the dental implant (2144).

In some embodiments, the removing the diseased bone is optionally performed by rotating the in-situ treatment tool.

In some embodiments, the removing the diseased bone and tissue is optionally performed by grinding, optionally using a rotating diamond ball tool at 60-70-200 thousand RPM.

In some embodiments, the removing an additional layer of healthy bone is optionally performed by rotating the in-situ treatment tool.

In some embodiments, the removing an additional layer of healthy bone is optionally performed by grinding, optionally using a rotating diamond ball tool at 60-70-200 thousand RPM.

In some embodiments, the in-situ treatment tool is optionally used to level a bone surface at a bottom of exposed dental implant.

In some embodiments, a hole is made in the jaw bone, to reach bone marrow to optionally cause bleeding, which potentially provides cells for growing bone.

In some embodiments, bone augmentation material, or bone-substrate, or bone dust is placed over the jaw bone and/or around the dental implant, to potentially build bone around the dental implant.

In some embodiments, a membrane is optionally placed to cover the bone augmentation material.

In some embodiments, a screw is optionally used to hold the membrane in place. In some embodiments, the screw passes through the membrane into the dental implant, optionally into the hole configured for attaching a crown.

In some embodiments, the gum flap is sewn over the membrane and/or the screw.

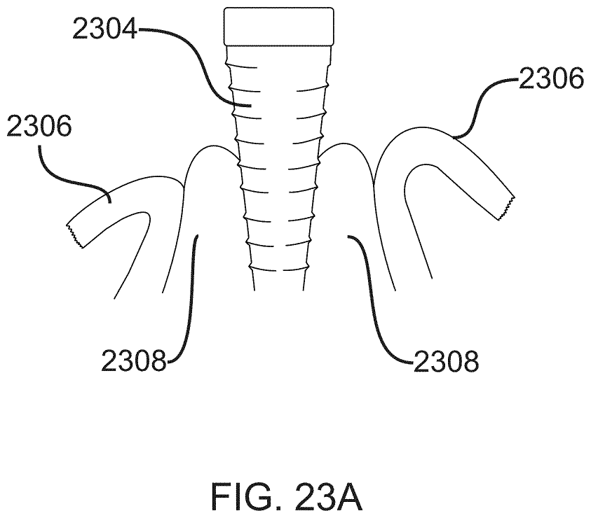

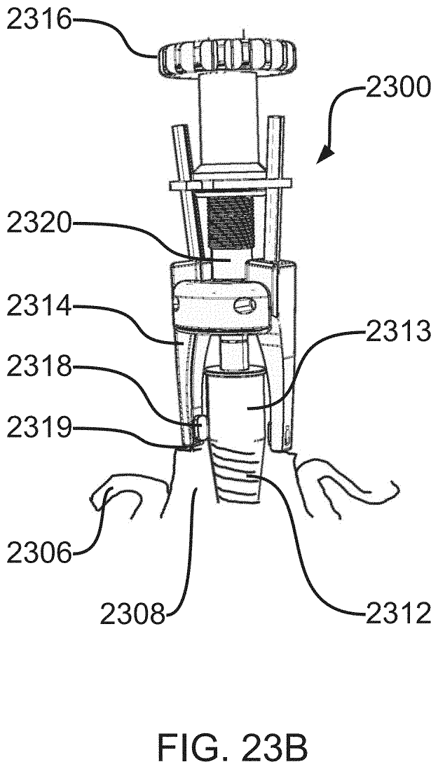

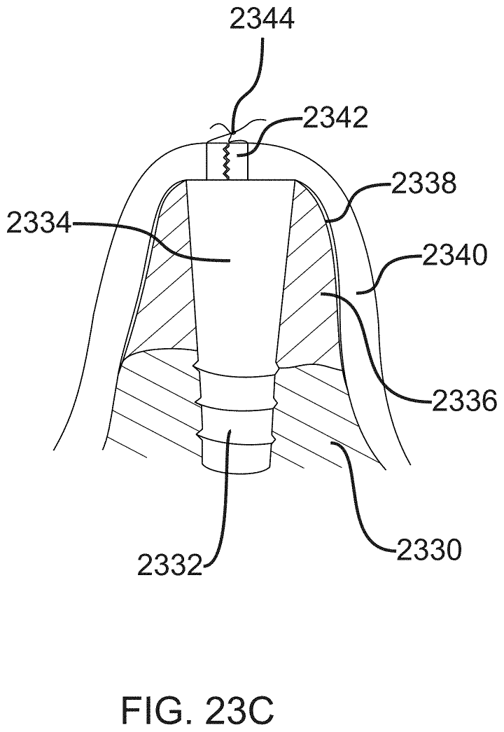

Reference is now made to FIG. 23A, which is a simplified line drawing of a dental implant with gums opened to expose the dental implant according to an example embodiment of the invention.

FIG. 23A shows a dental implant 2304, a diseased jaw bone 2308 and gum flaps 2306.

Reference is now made to FIG. 23B, which is a simplified line drawing of a dental implant with gums opened to expose the dental implant, and a device for in-situ treatment of the dental implant according to an example embodiment of the invention.

FIG. 23B shows a dental implant 2312, a diseased jaw bone 2308 and gum flaps 2306.

FIG. 23B also shows an example embodiment device 2300 as described and shown elsewhere herein, including in FIGS. 2A-F, 3, 4, 5A-B, 6A-F, 7A-B, 8A-B, 9A-B, 10, 11, 12, 13, 14, 16A-B, 17A-G, 18A-G and 19A-B.

The device 2300 includes, inter alia, a shaft 2320 and a knurled adjustment nut 2316 for adjusting spacing between tools 2314.

FIG. 23B shows the tools 2314 having an edge 2318 for cutting an outer surface of the dental implant 2312.

FIG. 23B shows a portion 2313 of the outer face of the dental implant 2312 where screw thread has been cut away and the outer surface of the portion 2313 of the outer face of the dental implant 2312 has been cut to be a smooth surface.

FIG. 23B shows the tools 2314 having a bottom edge 2319 optionally configured for cutting the jaw bone 2308.

In some embodiments, when the tool 2314 rotates, the optional bottom edge 2319 optionally cuts the jawbone 2308, optionally removing bone, and in some embodiment optionally leveling or flattening a surface of the jaw bone 2308.

Reference is now made to FIG. 23C, which is a simplified line drawing of a dental implant following in-situ treatment according to an example embodiment of the invention.

FIG. 23C shows a dental implant 2332, with a portion 2334 which has been treated in-situ. The dental implant 2332 is embedded in bone 23303.

FIG. 23C also shows bone augmentation material 2336 placed atop the bone 2330 and around the portion 2334 of the dental implant 2332.

FIG. 23C shows an optional membrane 2338 covering the bone augmentation material 2336.

FIG. 23C shows the optional membrane 2338 covering a top of the dental implant 2332, and a screw 2342 or pin 2342 inserted into the dental implant 2332 to anchor the membrane 2338.

FIG. 23C shows the gums 2340 sewn closed 2344, optionally closed over a top of the implant 2332, and/or over a top of the screw 2342.

It is expected that during the life of a patent maturing from this application many relevant dental implants will be developed and the scope of the term dental implant is intended to include all such new technologies a priori.

As used herein with reference to quantity or value, the term “about” means “within ±25% of”.

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

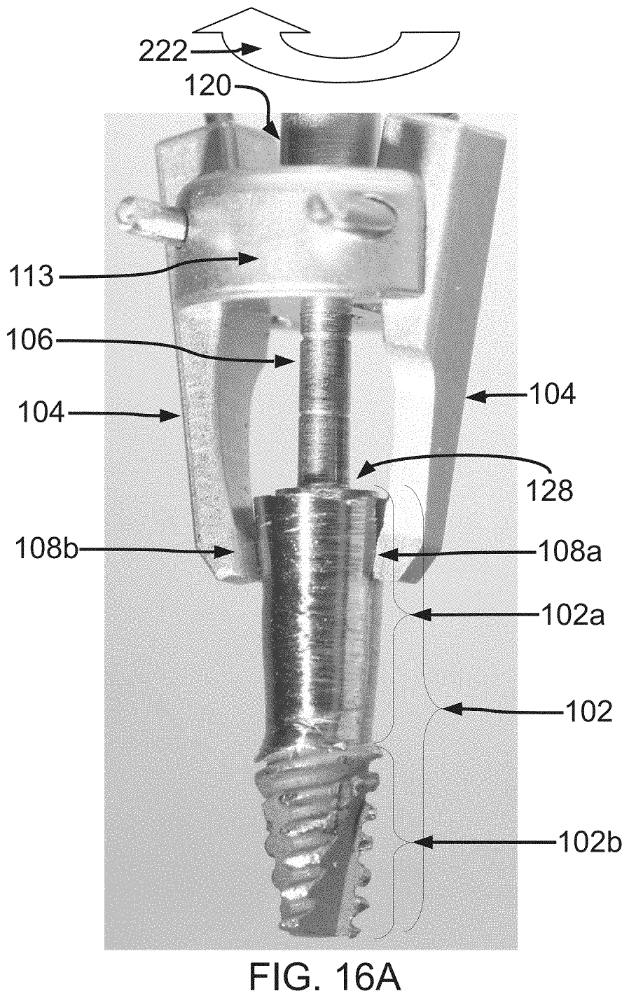

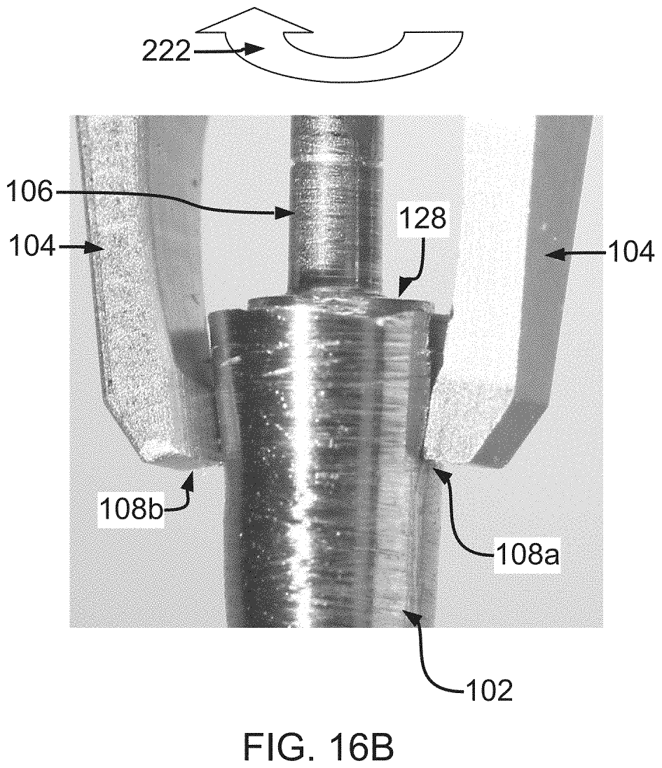

Reference is now made to FIG. 16A, which is a photograph of a device for treating a dental implant in-situ according to an example embodiment of the invention, located on a guide according to an example embodiment of the invention, and a dental implant.

FIG. 16A shows a photograph of an example embodiment device with only some specific components pointed out, in the interest of clarity.

The specific components include:

a shaft 120;

a tool carrier 113;

pins 223 acting as hinges for tools 104, located in holes in the tool carrier 113; and

tool tips edges 108a 108b.

FIG. 16A also shows an example embodiment of a guide 106 screwed into a dental implant 102, including a top of an optional conical portion 128.

FIG. 16A shows the dental implant 102 after the device has ground threads off a first portion 102a of an outer surface of the tool guide 102, leaving a second portion 102b of an outer surface of the tool guide 102 with threads.

The photograph of FIG. 16A is intended to illustrate how the example device can grind off an outer surface of a first portion 102a the dental implant 102, while leaving a second portion 102b still embedded with a bone (not shown).

FIG. 16A illustrates an example embodiments where a direction of rotation 222 of the shaft 120, the tool carrier 113 and the tools 104, is shown in the drawing. The direction of rotation causes the tool tip 108a to exert a force on the dental implant which is in accord with a direction of the threads of the dental implant 102—the direction 222 does not act in a direction which might unscrew the dental implant from the jaw.

FIG. 16A shows a tool tip edge 108a located upon the outer surface of the dental implant 102 and touching the outer surface of the dental implant 102 at a correct position to machine the outer surface, taking into account the direction of rotation 222. The tool tip edge 108b is shown “lagging” the outer surface of the dental implant 102, however an opposite edge (not shown) of the tool tip edge 108b is located at the correct position to machine the outer surface, symmetrically opposite the tool tip edge 108a.

Reference is now made to FIG. 16B, which is an enlarged portion of the photograph of FIG. 16A.

FIG. 16B shows a portion of the photograph of FIG. 16A which includes part of the tools 104; part of the guide 106, including a top of an optional conical portion 128; part of the guide 102, and the tool tip edges 108a 108b. FIGS. 16A-B also show the direction of rotation of the tools 104.

The photograph of FIG. 16B is intended to illustrate more clearly the positions of the toll tip edges 108a 108b.

FIG. 16B illustrates an example embodiments where the direction of rotation 222 of the tools 104 is shown in the drawing.

FIG. 16B shows the tool tip edge 108a located upon the outer surface of the dental implant 102 and touching the outer surface of the dental implant 102 at a correct position to machine the outer surface, taking into account the direction of rotation 222. The tool tip edge 108b is shown “lagging” the outer surface of the dental implant 102, however an opposite edge (not shown) of the tool tip edge 108b is located at the correct position to machine the outer surface, symmetrically opposite the tool tip edge 108a.

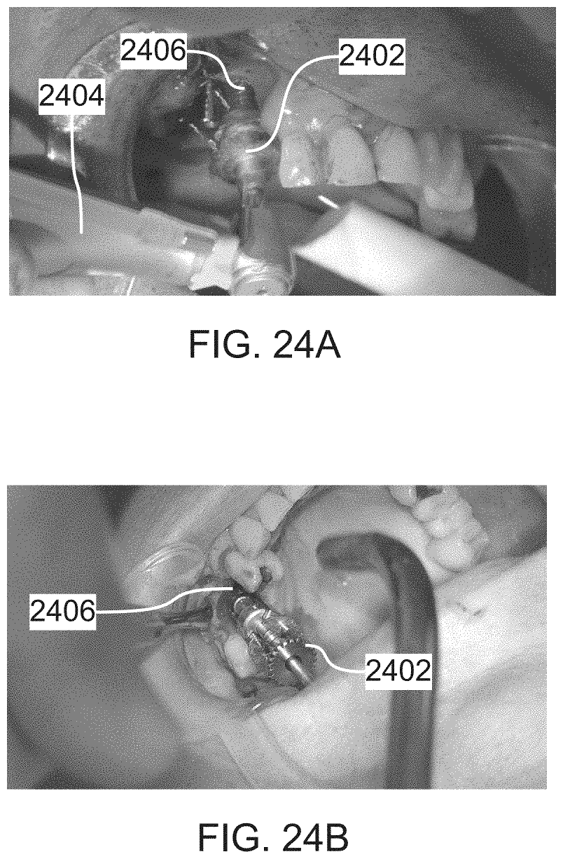

Reference is now made to FIG. 24A, which is a photograph of a device for treating a dental implant in-situ according to an example embodiment of the invention.

The photograph of FIG. 24A shows an example embodiment device 2402 for treating a dental implant in-situ, the device 2402 mounted on a standard dental hand-piece 2404, and treating a dental implant 2406 in-situ.

Reference is now made to FIG. 24B, which is a photograph of a device for treating a dental implant in-situ according to an example embodiment of the invention.

The photograph of FIG. 24B shows an example embodiment device 2334 for treating a dental implant in-situ, the device 2334 on a guide (not clearly visible) inserted into a dental implant 2406.

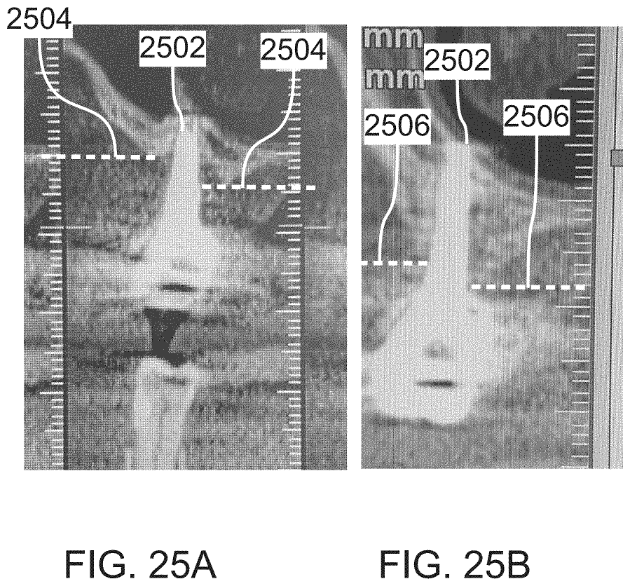

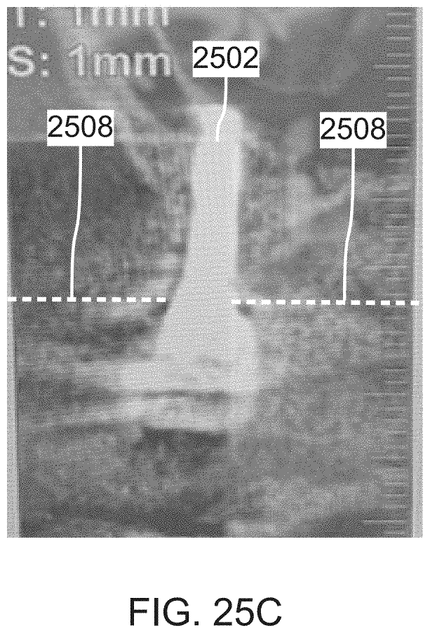

Reference is now made to FIGS. 25A-25C, which are X-ray photographs of a dental implant in-situ according to an example embodiment of the invention.

FIG. 25A shows a dental implant 2502 of a patient with peri-implantitis, before treatment, where bone has receded from the dental implant, to a level marked by reference line 2504.

FIG. 25B shows the dental implant 2502 of the patient approximately 3 months after treatment according to an example embodiment of the invention, where bone has grown further along the implant, to a level marked by reference line 2506.

FIG. 25C shows the dental implant 2502 of the patient approximately 12 months after treatment according to an example embodiment of the invention, showing that the bone has not subsequently receded following the treatment and growth, and is at a level marked by reference line 2508.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1-50. (canceled)

51. A device for treating a dental implant in-situ, the device comprising:
a shaft; and
a machining tool attached to the shaft at a location between the ends of the shaft, tips of the machining tool arranged to rotate around a longitudinal axis of the shaft when the shaft rotates,
wherein:
the shaft comprises a concentric hole at one end, the hole sized and shaped to slide over and rotate around a guide sized and shaped to be placed in a hole in a dental implant for steadying the shaft when the shaft rotates around the dental implant; and
the tip of the machining tool extends beyond a distal end of the shaft.

52. A device according to claim 51 wherein the shaft and the machining tools are sized to be inserted in a human mouth.

53. A device according to claim 51 wherein the device comprises the guide.

54. The device according to claim 52 wherein the guide comprises a thread sized and shaped to screw into the dental implant.

55. A device according to claim 51 comprising an adjustment nut, the adjustment nut arranged to move the tool tips in the radial direction relative to the longitudinal axis of the shaft.

56. A device according to claim 55 wherein the adjustment nut acts upon a floating ring to move the ring along the shaft without transferring a rotation of the adjustment nut to the tool tips.

57. A device according to claim 56 wherein the ring arranged to move the tool tips to press onto the outer surface of the dental implant by acting on a an inclined spring arm.

58. A device according to claim 51 wherein the tool tip is arranged to contact an outer surface of a dental implant at a location slightly behind a point where the radial direction relative to the longitudinal axis of the shaft intercepts the outer surface of the dental implant.

59. A device according to claim 51 wherein an edge of the tool is designed at an angle to remove bone.

60. A device according to claim 51 wherein the tools comprise a component selected from a group consisting of:
a cutting insert comprising a hard cutting tool material;
a brush;
an abrasive; and
an abrasive mount.

61. A guide for a device for treating a dental implant in-situ, the guide comprising:
a first portion shaped as a cylinder; and
a second portion with a diameter small enough to anchor into a hole in a center of a dental implant,
wherein a longitudinal axis of the cylinder of the first portion is concentric with a longitudinal axis of the second portion; and
the guide comprises a lip portion between the first portion and the second portion, the lip extending radially further than a radius of the dental implant.

62. The guide according to claim 61 wherein the second portion comprises a thread sized and shaped to screw into a dental implant.

63. A guide according to claim 61 wherein the guide is sized and shaped to enable a hole in a shaft of a device for treating a dental implant in-situ to slide over the guide and rotate around the guide.

64. A kit comprising:
a device for treating a dental implant in-situ, the device comprising:
a shaft; and
a machining tool attached to the shaft at a location between the ends of the shaft, tips of the machining tool arranged to rotate around a longitudinal axis of the shaft when the shaft rotates,
wherein:
the shaft comprises a concentric hole at one end, the hole sized and shaped to slide over and rotate around a guide sized and shaped to be placed in a hole in a dental implant for steadying the shaft when the shaft rotates around the dental implant; and
the tip of the machining tool extends beyond a distal end of the shaft; and
a guide according to claim 61.

65. A device for treating a dental implant in-situ, the device comprising:
a shaft comprising a tip sized and shaped to slide into a hole in a dental implant for steadying the shaft around the dental implant when rotating; and
a tool attached to the shaft at a location between the ends of the shaft, the tool tip arranged to rotate around a longitudinal axis of the shaft when the shaft rotates.

66. A method for treating a dental implant in-situ, the method comprising:
providing a device for treating a dental implant in-situ;
centering the device over a dental implant and sliding onto a guide;
adjusting treating tools to press onto an outer surface of the dental implant; and
lowering the device onto the guide, thereby lowering the tools along the outer surface of the dental implant, thereby removing the outer surface of the dental implant.

67. The method according to claim 66 wherein the device cuts flakes off the dental implant.

68. The method according to claim 66 wherein the guide is screwed into the dental implant before the device is slid over the guide.

69. The method according to claim 66 used for treating peri-implantitis.

70. The method according to claim 66 and further comprising:
opening gum at a location of a dental implant which exhibits peri-implantitis;
removing diseased bone and tissue.

71. The method according to claim 70 wherein the removing diseased bone and tissue comprises using the device to remove the diseased bone.

72. The method according to claim 66 wherein the device cuts flakes off the dental implant revealing a new machined surface.
